(19) United States
(12) Patent Application Publication
(10) Pub. No.: US 2025/0093292 A1
(43) Pub. Date: Mar. 20, 2025

(54) SENSOR FOR THE DETECTION OF HYDROXYL FREE RADICALS

(71) Applicant: The University of Toledo, Toledo, OH (US)

(72) Inventors: Dong Shik Kim, Toledo, OH (US); Ana C. Alba Rubio, Toledo, OH (US); Hamidreza Ghaedamini, Toledo, OH (US); Surachet Duanghathaipornsuk, Toledo, OH (US); Ibeh S. Omodolor, Toledo, OH (US)

(73) Assignee: The University of Toledo, Toledo, OH (US)

(21) Appl. No.: 18/370,111

(22) Filed: Sep. 19, 2023

(51) Int. Cl. G01N 27/327; G01N 27/30

(52) U.S. Cl. CPC G01N 27/3278; G01N 27/308; G01N 27/3277

(57) ABSTRACT

Compositions, devices, and methods for sensing free radicals such as hydroxyl radicals, involving cerium oxide nanoparticles, metal nanoparticles, and a conductive support on an electrode, are described.

### STATEMENT REGARDING FEDERALLY SPONSORED RESEARCH

This invention was made with government support under Grant Numbers 2141183 and 2023102 awarded by the National Science Foundation. The government has certain rights in this invention.

### RELATED APPLICATIONS

None.

### BACKGROUND

Reactive oxygen species (ROS) are extremely reactive chemicals generated from the incomplete reduction of molecular oxygen. This term not only includes free radicals such as superoxide (·O₂⁻), hydroxyl radicals (·OH), alkoxy radicals (RO·), and peroxyl radicals (ROO·), but also applies to non-radical reactive oxygen intermediates such as lipid hydroperoxide (LOOH), hydrogen peroxide (H₂O₂), and ozone (O₃). Free radicals are unstable chemicals with unpaired outermost electrons that are very reactive. As a result of losing or obtaining an unpaired electron, free radicals constantly strive to establish stable bonds. In plants, ROS are produced by aerobic organisms as a by-product of aerobic metabolism and as a consequence of prolonged exposure to harmful radiation. In mammals, mitochondrial enzymes and nicotinamide adenine dinucleotide phosphate (NADPH) oxidases (i.e., NOXs) are the main generators of ROS.

ROS play an important role in the regular physiological functions of our bodies when present at low concentrations. ROS are advantageous to living cells by serving as a defense mechanism against bacteria, as well as for intercellular signaling transduction and transcriptional activation. Although ROS benefit living cells, retaining these benefits involves an optimal degree of production. An imbalance between the generation and removal of ROS leads to oxidative stress in the human body, which damages nearby proteins, lipids, and DNA. Eventually, a high degree of oxidative stress may cause major diseases such as cancer, diabetes, skin aging, Alzheimer's disease, and Parkinson's disease.

In recent years, the detection of ROS has drawn a lot of attention in several domains. For instance, in biology, the capability of obtaining a real-time detection of ROS may facilitate greater comprehension of the roles that ROS play in plants, bacteria, and even in the mitochondria of human cells. Additionally, in the medical field, detecting ROS concentration changes at the early stages of diseases is important for pathological studies, health screening, and illness diagnosis. The fuel cell industry is another sector in which the detection of ROS is important since ROS are recognized for damaging proton exchange membranes and thereby limiting the lifetime of fuel cells.

As ROS detection technologies continue to develop, challenges remain, including a short lifespan, rapid diffusion rate, and diverse production sources, since these things may lead to imprecise and inconsistent measurements. Furthermore, their low and variable concentrations at the generating sites can make several approaches inappropriate for detecting ROS, particularly in living cells. Among ROS, hydroxyl radicals (·OH) are considered the most reactive and damaging species. In human cells, mitochondria are the primary organelles that produce ·OH via the incomplete reduction of molecular oxygen to generate water. The oxygen molecule is initially reduced to ·O₂⁻, which is then further reduced in the mitochondrial intermembrane to H₂O₂ before ultimately reducing to ·OH. ·OH radicals are primarily generated in a two-stage procedure. In the first stage, ferric ions are reduced to ferrous ions using ·O₂⁻ (Haber-Weiss reaction): Fe³⁺+·O₂⁻→Fe²⁺+O₂. Then, in the second stage, ferrous ions are oxidized by H₂O₂ to produce Fe³⁺ and ·OH (Fenton reaction): Fe²⁺+H₂O₂→Fe³⁺+OH⁻+·OH.

Hydroxyl free radicals may react with any cellular component, significantly damaging lipids and proteins, leading to membrane breakdown, lipid peroxidation, and protein degradation. Consequently, the overproduction of ·OH can harm neighboring cells, causing the development of oxidative stress-related illnesses. Many approaches for the detection of ·OH have been developed, including mass spectrometry (MS), electron spin resonance (ESR), high-performance liquid chromatography (HPLC), metal oxidation methods, colorimetric methods, fluorescence spectroscopy, or electro paramagnetic resonance (EPR). However, most of these methods are expensive, incapable of providing quick responses, difficult to detect in situ, time-consuming, inaccurate, or inconsistent. Furthermore, these methods cannot perform real-time detection, and cannot detect at a concentration lower than 1 mM. An electrochemical technique is an alternative to other approaches because of its high sensitivity, selectivity, economic feasibility, quick response, and potential for in situ real-time detection. Organic and inorganic electrochemical sensing materials have been integrated with electrochemical techniques to detect ·OH. For instance, DNA, organic molecules, and conductive polymers are among the components used in organic-based electrochemical sensors. Although biological materials have shown to be promising candidates for ·OH detection, the use of these molecules has the disadvantages of denaturation and instability at certain temperatures and pHs, resulting in poor sensor performance.

To overcome these challenges, inorganic materials, such as cerium oxide nanoparticles (CeNPs), with enzyme-mimetic capabilities have been utilized for the detection of ·OH. Cerium oxide (CeO₂ or Ce₂O₃) is an effective scavenger for ·OH. Due to the dual oxidation state of cerium in cerium oxide, which can rapidly switch between Ce³⁺ and Ce⁴⁺, cerium oxide has an exceptional capacity for scavenging ·OH. As shown in FIG. 1, Ce³⁺ sites on cerium oxide selectively react with ·OH through an oxidation process and are converted into Ce⁴⁺ sites. Then, Ce⁴⁺ can be reduced reversibly to Ce³⁺ through a reduction process.

As Ce³⁺ sites are responsible for the interaction with ·OH, many studies have focused on reducing the size of cerium oxide nanoparticles in order to increase the number of Ce³⁺ sites and boost their ·OH scavenging ability. As an example, some have employed surface organometallic chemistry (SOMC) to synthesize nanoscale CeOₓ in order to increase the number of Ce³⁺ sites for electrochemical detection of ·OH. Using the SOMC technique, CeOₓ nanoclusters have been anchored on a highly conductive carbon to increase the conductivity of the sensor, thus improving its electrochemical performance. However, there is still an opportunity for improvement.

In sum, there is a need in the art for new and improved compositions, devices, and methods for sensing free radicals such as hydroxyl radicals.

### SUMMARY

Provided herein is a sensing composition comprising a conductive support; and a sensing matrix on the conductive support, wherein the sensing matrix comprises cerium oxide nanoparticles on, or intermingled with, metal nanoparticles. In certain embodiments, the metal nanoparticles are decorated with the cerium oxide nanoparticles.

In certain embodiments, the metal nanoparticles comprise gold nanoparticles. In certain embodiments, the metal nanoparticles consist of gold nanoparticles. In particular embodiments, the sensing matrix includes an atomic ratio of Au:Ce of about 1:0.075.

In certain embodiments, the cerium oxide nanoparticles comprise nanoislands.

In certain embodiments, the conductive support comprises a conductive, amorphous carbon. In certain embodiments, the conductive support comprises carbon black.

In certain embodiments, the sensing composition is free of Prussian blue. In certain embodiments, the sensing composition is free of graphene and graphene oxide. In certain embodiments, the sensing composition is free of Prussian blue, graphene, and graphene oxide.

Further provided is a sensor comprising the sensing composition described herein in electrical communication with an electrode, wherein the electrode is configured to act as a transducer for the sensing composition, and the sensor is capable of detecting hydroxyl radicals generated by the Fenton reaction. The sensor is also capable of detecting hydrogen peroxide (H₂O₂), although the sensor's sensitivity with hydroxyl radicals is orders of magnitude higher than with H₂O₂.

In certain embodiments, the electrode is a working electrode on a sensing area and the sensor further comprises a counter electrode on the sensing area.

In certain embodiments, the metal nanoparticles comprise gold nanoparticles.

In certain embodiments, the electrode is a screen-printed carbon electrode. In particular embodiments, the screen-printed carbon electrode comprises a carbon working electrode, a carbon auxiliary electrode, and an Ag/AgCl reference electrode.

In certain embodiments, the sensor is in a hand-held sensor device.

Further provided is a method of detecting free radicals, the method comprising exposing the sensor device described herein to free radicals, and analyzing cyclic voltammetry or electrochemical impedance spectroscopy data from the sensor device to detect free radicals. In certain embodiments, the free radicals comprise hydroxyl radicals or hydrogen peroxide.

Further provided is a method for making a sensing composition, the method comprising depositing or precipitating metal nanoparticles onto a conductive carbon support to form carbon-supported metal nanoparticles; and decorating the carbon-supported metal nanoparticles with cerium oxide nanoparticles to form a sensing composition.

In certain embodiments, the decorating comprises selectively depositing CeOₓ nanoislands onto the metal nanoparticles by controlled surface reactions to create small CeOₓ clusters.

In certain embodiments, the method further comprises making a sensor device by electrically contacting the sensing composition with an electrode.

In certain embodiments, the depositing or precipitating metal nanoparticles comprises dissolving a gold precursor in a solvent to obtain a solution; adjusting the pH of the solution to 9; adding a conductive, amorphous carbon to the solution and adjusting the pH of the solution to 9 again; stirring and filtering the solution to obtain a Au/carbon composite; washing the Au/carbon composite to remove anions from the gold precursor; drying the Au/carbon composite; reducing the Au/carbon composite to form a reduced Au/carbon composite; and passivating the reduced Au/carbon composite to form carbon-supported nanoparticles. In particular embodiments, the gold precursor comprises gold (III) chloride trihydrate.

In certain embodiments, the decorating comprises reducing the carbon-supported nanoparticles to remove a passivation layer and obtain reduced carbon-supported nanoparticles; dissolving a cerium oxide precursor in a solvent to obtain a precursor solution; mixing the precursor solution with the reduced carbon-supported nanoparticles to obtain a reaction solution; removing the solvent from the reaction solution to obtain a product; reducing the product to obtain a reduced product; and passivating the reduced product to form the sensing composition. In particular embodiments, the cerium oxide precursor comprises tris (cyclopentadienyl) cerium (III).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Redox reaction between cerium oxide and ·OH.

FIG. 2: Illustration of a non-limiting example sensor for detecting free radicals as described herein. The sensor includes a sensing matrix composed of cerium oxide nanoparticles on metal nanoparticles, where the sensing matrix is on a conductive support and the conductive support is on an electrode.

FIGS. 3A-3E: Illustrations of non-limiting example sensors for free radical detection. FIG. 3A shows a perspective view of a sensor with a probe tip. FIG. 3B shows a perspective view of a sensor without a probe tip. FIG. 3C shows a side view of a sensor without a probe tip. FIG. 3D shows a bottom view of a sensor without a probe tip. FIG. 3E shows a schematic of a sensor in the form of a hand-held unit.

FIG. 4: Schematic of the preparation of the CeOₓ—Au/carbon-modified electrode and experimental setup for the detection of ·OH in the examples herein.

FIGS. 5A-5B: TEM images (200,000× magnification in FIG. 5A and 100,000× magnification in FIG. 5B) of Au/carbon synthesized by the deposition-precipitation method.

FIGS. 6A-6B: TEM images (200,000× magnification in FIG. 6A and 100,000× magnification in FIG. 6B) of the 3×CeOₓ—Au/carbon sample synthesized by selective deposition of CeOₓ by controlled surface reactions (CSR) over carbon-supported AuNPs.

FIGS. 7A-7E: Energy dispersive spectrometry (EDS) elemental mapping of a 3×CeOₓ—Au/carbon sample showing the decoration of the AuNPs with CeOₓ.

FIGS. 8A-8B: Cyclic voltammograms of the bare electrode (black), the CeOₓ/carbon-modified electrode (blue), and the CeOₓ—Au/carbon-modified electrode (red) in 5 mM of ·OH (FIG. 8A), and normalized redox response (per mass of Ce) obtained with the CeOₓ/carbon (blue) and CeOₓ—Au/carbon (red) composites toward 5 mM of ·OH (FIG. 8B).

FIGS. 9A-9B: Cyclic voltammograms of the CeOₓ—Au/carbon-modified electrode toward 5 mM ·OH in the pH range 1 to 7 (FIG. 9A), and redox response of the CeOₓ—Au/carbon-modified electrode to 5 mM ·OH vs. pH (FIG. 9B).

FIGS. 10A-10B: Cyclic voltammograms with the CeOₓ—Au/carbon-modified electrode at scan rates from 20 to 200 mV s⁻¹ in 5 mM ·OH (FIG. 10A), and relationship between the peak current response and the scan rate (v) (FIG. 10B).

FIGS. 11A-11B: Cyclic voltammograms obtained with the CeOₓ—Au/carbon-modified electrode and different concentrations of ·OH from 0.05 to 5 mM (FIG. 11A), and relationship between the redox response of the CeOₓ—Au/carbon-modified electrode and ·OH concentration (FIG. 11B).

FIGS. 12A-12B: Phase angle shifts in the Bode plot obtained with the CeOₓ—Au/carbon-modified electrode using EIS and a frequency range of 10-2 to 104 Hz in the presence of H₂O₂ and ·OH (FIG. 12A), and redox response of the CeOₓ—Au/carbon-modified electrode to 5 mM ·OH and 10 mM H₂O₂ (FIG. 12B). The error bars represent the standard deviation of four repetitive measurements.

FIGS. 13A-13C: Reproducibility analysis with six different modified electrodes (error bars represent the standard deviation of four repetitive measurements) (FIG. 13A), and repeatability study using a single electrode for six repeated tests (FIG. 13B). FIG. 13C shows that the peak current of CV did not change significantly after more than 100 cycles of continuous scanning at 100 mV s⁻¹, pointing to the excellent stability of the nanocomposite.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein are compositions, devices, and methods useful for detecting, sensing, scavenging, or removing free radicals such as, but not limited to, hydroxyl radicals (·OH). As noted above, hydroxyl free radicals are known as important chemicals for maintaining the normal activities of human cells. However, an excessive concentration of hydroxyl free radicals disrupts their normal function, causing various diseases, including liver and heart diseases, cancers, and neurological disorders. The detection of hydroxyl free radicals as biomarkers is thus important for the early diagnosis of these serious conditions, among other applications.

In accordance with the present disclosure, the strong affinity of cerium oxide nanoparticles for hydroxyl free radicals can be utilized to develop a highly sensitive sensor by decorating metal nanoparticles with cerium oxide nanoparticles. In general, free radical sensing compositions and devices can be made using cerium oxide nanoparticles (CeNPs) combined with metal nanoparticles such as gold nanoparticles (AuNPs) to form a sensing matrix. The sensing matrix can be disposed on a conductive support such as a highly conductive carbon to form a sensing composition. The sensing composition can be disposed on, in contact with, or otherwise in electrical communication with one or more electrodes to make a sensor device capable of detecting hydroxyl free radicals or hydrogen peroxide. The sensing device can be a reusable sensor with the ability to detect ROS accurately and consistently, and may be a hand-held device capable of real-time detection of ROS such as, but not limited to, hydroxyl radicals.

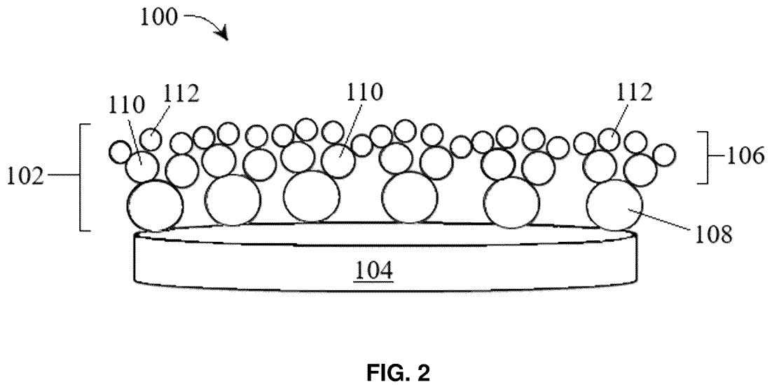

Referring now to FIG. 2, depicted is a non-limiting example sensor 100 that includes a sensing composition 102 disposed on, or otherwise in electrical communication with, an electrode 104, where the sensing composition 102 is composed of a sensing matrix 106 on a conductive support 108. The sensing matrix 106 includes metal nanoparticles 110 decorated with cerium oxide nanoparticles 112. The term “decorated” in this context means the cerium oxide nanoparticles 112 are intermingled with, on, or otherwise contacting, the metal nanoparticles 110. The sensing matrix 106 is disposed on the conductive support 108 such that the metal nanoparticles 110 are on, and in direct contact with, the conductive support 108 to form the sensing composition 102. In the embodiment depicted in FIG. 2, the cerium oxide nanoparticles 112 are disposed on the metal nanoparticles 110 only and do not directly contact the conductive support 108. However, this is not strictly necessary, and embodiments in which the cerium oxide nanoparticles 112 contact the conductive support 108 in addition to contacting the metal nanoparticles 110 are encompassed within the scope of the present disclosure.

Referring still to FIG. 2, the conductive support 108 is disposed on, in direct contact with, or otherwise in electrical communication with, the electrode 104. Thus, it is possible to have one or more intervening conductive layers or materials between the conductive support 108 and the electrode 104 provided that the intervening conductive layers or materials are capable of communicating electrical signals from the conductive support 108 to the electrode 104. Furthermore, in the embodiment depicted in FIG. 2, the conductive support 108 is in direct contact with the electrode 104 while the metal nanoparticles 110 and the cerium oxide nanoparticles 112 are not. However, this is not strictly necessary, and embodiments in which either of the metal nanoparticles 110 or the cerium oxide nanoparticles 112 directly contact the electrode 104 are encompassed within the scope of the present disclosure.

Referring still to FIG. 2, the sensing matrix 106 includes both cerium oxide (CeOₓ) nanoparticles 112 and metal nanoparticles 110. The term “CeOₓ” as used herein refers to cerium oxide that may be in the form of Ce₂O₃, CeO₂, or a combination thereof. The sensing matrix 106 may made as a nanocomposite of CeOₓ-metal with a conductive support 108 such as a highly conductive carbon. Such a nanocomposite of CeOₓ-metal/carbon can be deposited on a suitable electrode 104, such as a screen-printed carbon electrode, to form the sensor 100. When in contact with ·OH, a redox reaction takes place between one of the cerium oxide nanoparticles 112 and the hydroxyl radical, generating a single electron which is then transferred through the metal nanoparticles 110 and conductive support 108 to the electrode 104. The electrode 104 acts as a transducer and converts the reaction into an electrical signal measurable using cyclic voltammetry (CV) or electrochemical impedance spectroscopy (EIS). In this manner, the sensor 100 detects the presence of the hydroxyl radical in a measurable way.

Referring still to FIG. 2, the cerium oxide nanoparticles 112 are particles of CeOₓ with three external nanoscale dimensions. The cerium oxide nanoparticles 112 may have an average particle size ranging from about 1 nm to about 100 nm. The particle size of the cerium oxide nanoparticles 112 can be adjusted as desired, for example by changing reaction parameters such as precursor concentration, reaction temperatures, reaction times, and the use of stabilizing agents. The cerium oxide nanoparticles 112 may be in the form of nanoislands, which can exist in various shapes, such as droplets, and can be made from thin metal films by annealing the thin films or by the dewetting of the thin films causing them to come together. Nanoislands, which are also known as nanoclusters or nanodots, are small assemblies or agglomerations of atoms or molecules that form on a substrate or surface at the nanoscale.

The cerium oxide nanoparticles 112 can be small clusters of CeOₓ nanoparticles deposited on the metal nanoparticles 110. Small clusters of CeOₓ can boost the electrochemical response in the Fenton reaction. The cerium oxide nanoparticles 112 can be made by controlled surface reactions (CSR) on the metal nanoparticles 110. For example, the metal nanoparticles 100 (which may already be on the support 108 prior to the synthesis or deposition of the cerium oxide nanoparticles 110) can be reduced to remove a passivation layer, then contacted and mixed with a precursor solution containing a cerium oxide precursor in a solvent. The cerium oxide precursor can be, for example, tri (cyclopentadienyl) cerium (III). However, other cerium oxide precursors are possible and encompassed within the scope of the present disclosure. The solvent can be removed and the resulting product can be reduced and passivated to yield the sensing matrix 106 of metal nanoparticles 110 decorated with cerium oxide nanoparticles 112. However, other methods for making the cerium oxide nanoparticles 112 or depositing the cerium oxide nanoparticles 112 on the metal nanoparticles 110 are possible and encompassed within the scope of the present disclosure. For example, the cerium oxide nanoparticles 112 can be made through various deposition, vapor condensation, or self-assembly processes. In any event, characterization techniques such as transmission electron microscopy (TEM) and energy dispersive X-ray spectroscopy (EDS) can be used to confirm the decoration of the metal nanoparticles 110 with the cerium oxide nanoparticles 112.

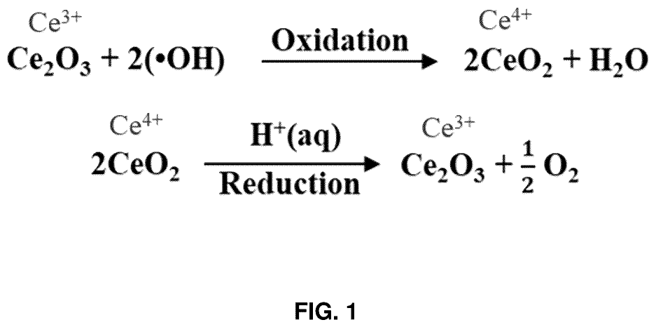

The outstanding ability of cerium oxide nanoparticles for scavenging ·OH radicals is due to its dual oxidation state, in which the cerium can easily switch between Ce³⁺ and Ce⁴⁺ by reducing or oxidizing species in a medium. In the typical redox reaction with hydroxyl radicals, cerium (III) oxide is oxidized to cerium (IV) oxide with two moles of hydroxyl radicals (FIG. 1). The Ce³⁺ oxidation state is believed to act as the active site for the redox reaction that scavenges ·OH radicals, as depicted in FIG. 1. The size and shape of cerium oxide nanoparticles also have an effect on the ·OH radical scavenging capacity, such that the scavenging capacity is better with, for example, 25 nm cerium oxide nanoparticles compared to 50 nm cerium oxide nanoparticles, and this difference is explained by the larger surface area and higher defect density of smaller cerium oxide nanoparticles. Consequently, the particle concentration of cerium oxide nanoparticles are important factors in constructing a highly sensitive and selective electrochemical composite sensors for ·OH radical detection and scavenging.

Referring still to FIG. 2, the metal nanoparticles 110 can have an average particle size ranging from about 1 nm to about 100 nm. The metal nanoparticles 110 can be, for example, gold nanoparticles (AuNPs). AuNPs in particular are advantageous among for the development of sensors due to their exceptional catalytic activity. AuNPs have the ability to significantly boost the conductivity of the sensor 100, hence increasing the sensor sensitivity. The incorporation of AuNPs in the sensor 100 can lead to improved performance, enhanced selectivity and accuracy, and increased biocompatibility and stability, making them a valuable asset in the development of advanced sensing platforms. The synergy between CeOₓ, AuNPs, and carbon, which contributes to high conductivity, electrocatalytic properties, and the small size of CeOₓ via the decoration of metal nanoparticles 110, provides the sensor with enhanced electrochemical performance in the Fenton reaction. Although gold is described for exemplary purposes and is particularly useful in combination with the cerium oxide nanoparticles 112, the metal nanoparticles 110 can be, or can include, metals other than gold so long as the metal nanoparticles 110 are capable of supporting the cerium oxide nanoparticles 112 and transferring electrical signals from the cerium oxide nanoparticles 112 to the conductive support 108.

Referring still to FIG. 2, the sensing matrix 106 can have an atomic ratio of metal:Ce ranging from about 1:0.005 to about 1:0.5, or from about 1:0.5 to about 1:0.02. In one non-limiting example, the metal nanoparticles 110 are gold nanoparticles and the sensing matrix 106 has an atomic ratio of Au:Ce of about 1:0.075. A metal: Ce atomic ratio in the range of from about 1:0.005 to about 1:0.5 allows for a small size and high concentration of Ce³⁺ sites. The metal: Ce atomic ratio can be controlled, for example, by adjusting the number for successive CSR cycles used to deposit the cerium oxide nanoparticles 112 on the metal nanoparticles 110. However, other methods for adjusting the metal: Ce atomic ratio are possible and encompassed within the scope of the present disclosure.

Referring still to FIG. 2, the sensing matrix 106 can have a metal loading in the range of from about 0.5 wt % to about 15 wt %, or from about 1 wt % to about 10 wt %. In one non-limiting example, the sensing matrix 106 has a metal loading of about 4.21 wt %. The sensing matrix 106 can have a cerium oxide loading in the range of from about 0.05 wt % to about 5 wt %, or from about 0.1 wt % to about 1.0 wt %. In one non-limiting example, the sensing matrix 106 has a cerium oxide loading of about 0.227 wt %.

Referring still to FIG. 2, the conductive support 108 serves as a stable platform for the deposition of the metal nanoparticles 110, providing a conductive matrix that enhances electron transfer between the sensing matrix 106 and the electrode 104. The conductive support 108 can be any suitable conductive material capable of having metal nanoparticles 110 deposited thereon and communicating an electrical signal from the metal nanoparticles 110 to the electrode 104. Non-limiting example materials useful as the conductive support include highly conductive, amorphous carbons such as carbon black. However, other conductive materials are possible and encompassed within the scope of the present disclosure.

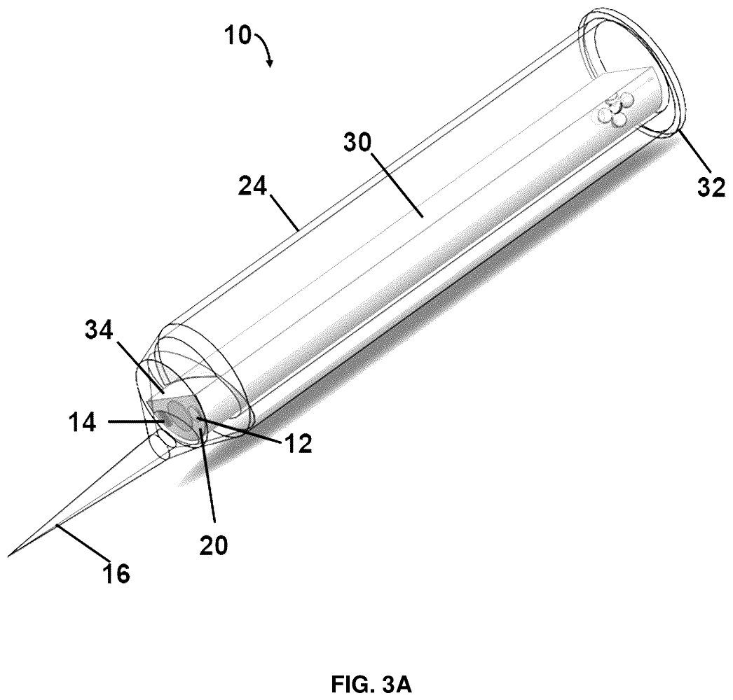

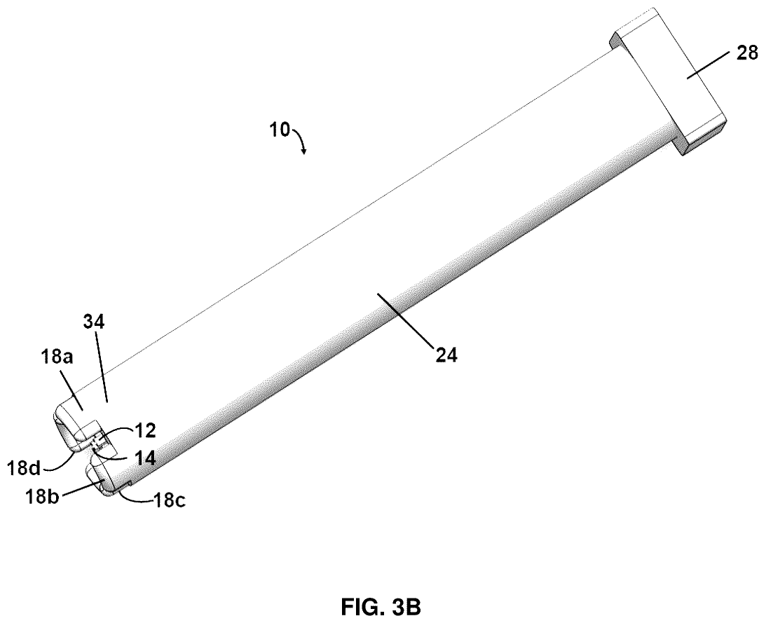

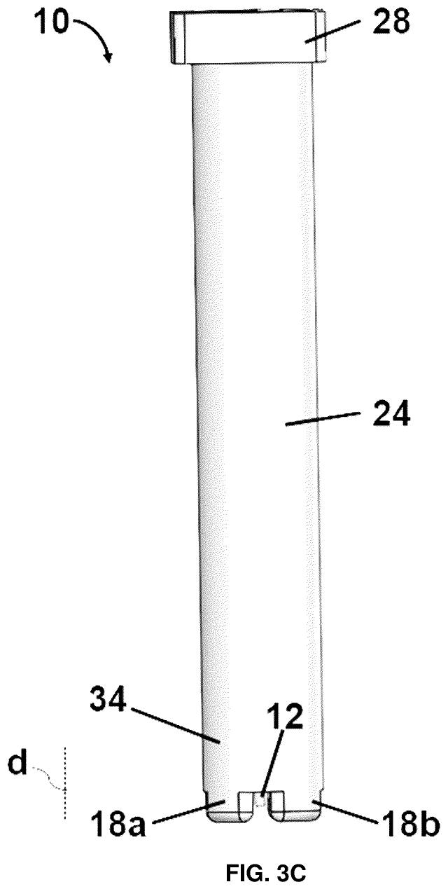

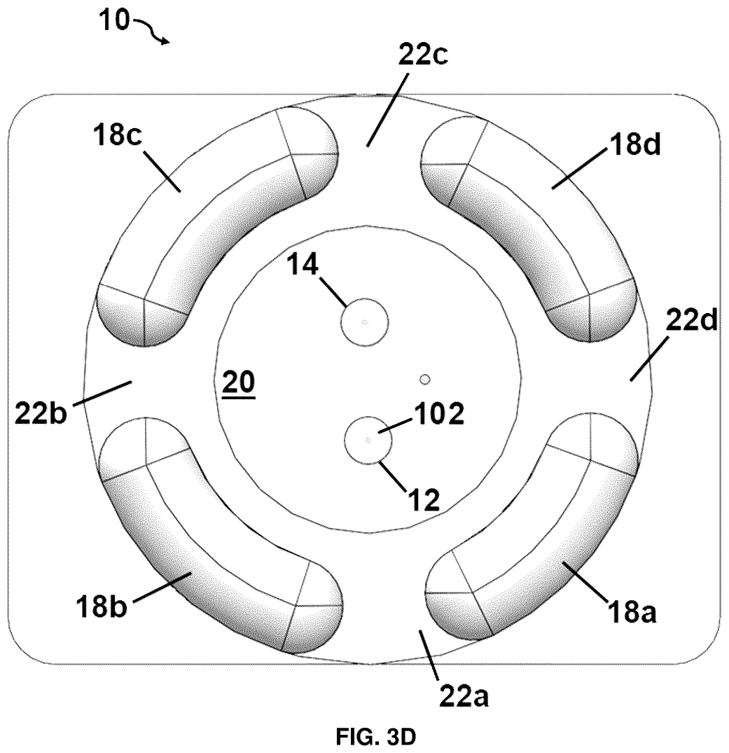

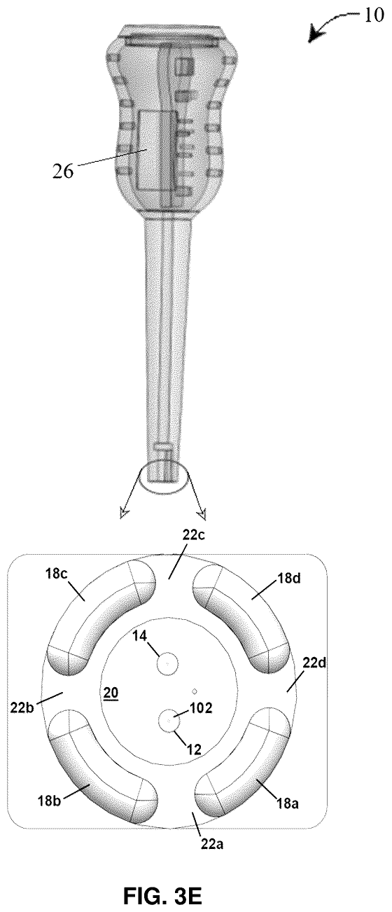

Referring still to FIG. 2, the electrode 104 may be, for example, a screen-printed carbon electrode (SPCE). SPCEs are highly effective tools in the creation of disposable sensors for electroanalysis. SPCEs have numerous advantages, including their design versatility, reproducibility of sensor fabrication, and low production cost. However, many other electrodes 104 are possible and encompassed within the scope of the present disclosure. Further, as discussed in more detail below with reference to FIGS. 3A-3D, the electrode 104 may be or may include a plurality of electrode components in a multi-electrode system. In one non-limiting example, the electrode 104 is a screen-printed carbon electrode composed of a 2 mm-diameter carbon working electrode, a carbon auxillary electrode, and an Ag/AgCl reference electrode.

Referring still to FIG. 2, the sensor 100 can be made through a process that involve loading the metal nanoparticles 110 onto the conductive support 108, then decorating the metal nanoparticles 110 with the cerium oxide nanoparticles 112 to form the sensing composition 102, and then depositing the sensing composition 102 on the electrode 104. The metal nanoparticles 110 can be loaded onto the conductive support 108 by, for example, a deposition-precipitation technique. The metal nanoparticles 110 can then be decorated with the cerium oxide nanoparticles 112 by controlled surface reactions (CSR) or any other technique capable of depositing the cerium oxide nanoparticles 112 on the metal nanoparticles 110. The sensing composition 102 can be deposited onto the electrode 104 through any suitable method, such as a deposition technique in which a solution of the sensing composition 102 is added dropwise to the electrode 104 and dried at an elevated temperature. For example, the composition-coated-electrode can be dried at about 60° C. for about 1 hour to obtain the sensor 100. Optionally, the formed sensor 100 can be rinsed with DI water and further dried under nitrogen. Characterization techniques such as transmission electron microscopy (TEM) and energy dispersive X-ray spectroscopy (EDS) can be used to confirm the distribution of the sensing composition 102 on the electrode 104.

The combination of cerium oxide nanoparticles 112 and metal nanoparticles 110 enhances the conductivity and allows for using a reduced size of cerium oxide nanoparticles 112, resulting in improved electrochemical performance of the sensor 100. The metal nanoparticles 110 have a high surface area-to-volume ratio that provides a large number of active sites for the dispersion of the cerium oxide nanoparticles 112, preventing the agglomeration of CeOₓ. Gold nanoparticles in particular have a high surface area-to-volume ratio, which provides a large number of active sites for the dispersion of CeOₓ domains and prevents agglomeration of CeOₓ. This contributes to the high conductivity, electrocatalytic property, and small size of CeOₓ possible to make the sensor 100 through the decoration of metal nanoparticles 110. Hence, the integration of cerium oxide nanoparticles 112, metal nanoparticles 110, and a conductive support 108 in the sensor 100 results in a synergistic enhancement of the electrochemical performance in detecting hydroxyl radicals. The electrochemical sensor 100 shows a high sensitivity toward ·OH produced through the Fenton reaction. In terms of selectivity, the sensor 100 has the capability to differentiate ·OH from other oxidizing chemicals, such as H₂O₂. Moreover, the sensor 100 meets conventional electrochemical sensor requirements, such as reusability, stability, repeatability, and reproducibility. As shown in the examples here, the sensor 100 made from cerium oxide nanoclusters, gold nanoparticles, and a highly conductive carbon on a screen-printed electrode can be used to detect free radicals, including hydroxyl free radicals, with an improved LOD compared to known methods and devices. The metal nanoparticles 110 boost the ability of the cerium oxide nanoparticles 112 to detect ·OH.

The sensor 100 has various improvements over previous free radical sensors. In contrast to the present disclosure, previous sensors using cerium oxide nanoparticles have involved, for example, cerium oxide nanoparticles grafted directly on a highly conductive carbon, or a CeOₓ/graphene oxide (GO) composite deposited on top of a Prussian blue coating on a carbon electrode surface. However, such sensors have limitations due to the agglomeration of cerium oxide nanoparticles during the synthesis process, which results in poor electrochemical performance. The sensor 100 described herein does not suffer from the agglomeration of cerium oxide nanoparticles 112 the way that previous sensors do. The integration of cerium oxide nanoparticles 112 with metal nanoparticles 110, especially carbon-supported AuNPs, prevents the agglomeration of cerium oxide nanoparticles 112, which results in improved electrochemical performance. The previous sensors containing Prussian blue also suffer from the degradation of the Prussian blue layer upon exposure to hydroxyl radicals, which limits those sensors to a single use. The sensor 100 described herein is not limited to a single use. Thus, the incorporation of metal nanoparticles as described herein prevents the agglomeration of cerium oxide clusters, enhances the electrochemical response, and improves the stability and accuracy of the sensor 100. The current response of the sensor 100 is higher than that of previous sensors, and the redox peak potential difference of the sensor 100 is considerably lower than that of previous sensors. The sensor 100 also works faster with a higher accuracy. Advantageously, the sensing matrix 106, sensing composition 102, and sensor 100 may be completely free of Prussian blue, may be completely free of graphene, and may be completely free of graphene oxide.

Referring now to FIGS. 3A-3E, a non-limiting example sensor 10 with a multiple electrode configuration is depicted. The sensor 10 includes a sensing composition 102 as described herein on a working electrode 12, where the sensing composition 102 comprises cerium oxide nanoparticles and metal nanoparticles on a conductive support. The sensor 10 may further include a counter electrode 14. The working electrode 12 and the counter electrode 14 are best seen in FIG. 3D. The working electrode 12 and the counter electrode 14 may be, for example, screen printed electrodes. The sensor 10 directly interacts with the area where the source of free radical generation is. The sensor 10 may be utilized for real-time free radical detection.

In some embodiments, the sensor 10 may include an elongated body 30 housed within a sheath 24 having a probe tip 16 designed to contact the area to be measured without the electrodes 12, 14 experiencing disturbances from surrounding non-specific solid materials. The probe tip 16 can work in contact with the area or it can be easily inserted into the area to be measured. The probe tip 16 is an elongated hollow member providing access to the sensing area 20 at the distal end 34 of the elongated body 30, where the working electrode 12 and counter electrode 14 are disposed. The probe tip 16 can be directly introduced into tissue or liquid samples. The probe tip 16 can ensure the sensing area 20 interfaces directly with the target area where sensing is intended to take place. The sensor 10 may further include a removable cap 28 at a proximal end 32 of the sensor 10. The removable cap 28 may be removed to allow access into the sheath 24.

Referring still to FIGS. 3B-3E, in some embodiments, the sensor 10 may include a sheath 24 that does not include the probe tip 16. The sensor 10 may include curved ridges 18a, 18b, 18c, 18d that extend a distance d beyond the elongated body 30, the sheath 24, and the sensing area 20 to keep a distance d between the surface of the object to be sensed (for example, human tissue) and the sensing area 20. In this manner, the sensing composition 102 only contacts fluid on the surface of the object. In one non-limiting example, the distance d is about 10 microns. However, other distances are possible and entirely encompassed within the scope of the present disclosure. The orientation of the curved ridges 18a, 18b, 18c, 18d may leave four openings 22a, 22b, 22c, 22d through which fluid may flow when the curved ridges 18a, 18b, 18c, 18d are in contact with the surface to be sensed. The sensing area 20 may be defined as a circular area bounded by the curved ridges 18a, 18b, 18c, 18d and the openings 22a, 22b, 22c, 22d. However, other orientations and numbers of curved ridges 18 and openings 22 are entirely possible and encompassed within the scope of the present disclosure.

Referring now to FIG. 3E, the sensor 10 may be in the form of a hand-held device and may include a display 26 configured to show sensing results or to select options. The sensor 10 does not need to include the probe tip 16 as shown in FIG. 3A. The sensing area 20 includes a working electrode 12 and a counter electrode 14, where the sensing composition 102 is disposed on the working electrode 12 but not the counter electrode 14. The sensor 10 can be used, for example, to aid in cancer removal surgeries, where a surgeon must determine how much tissue to remove around a tumor. The surgeon may use the sensor 10 to determine a radius of tissue around the tumor where the ROS concentration is high enough to warrant removal of the tissue so as to ensure removal of all the cancerous cells.

Cyclic voltammetry (CV) and electrochemical impedance spectroscopy (EIS) can be used to characterize the signals generated by the sensors described herein from the interaction of the nanocomposite with hydroxyl radicals. As demonstrated in the examples herein, non-limiting example sensors may have a limit of detection of about 58 μM, and can distinguish between hydroxyl radicals and similar ROS such as hydrogen peroxide (H₂O₂).

### EXAMPLES

An electrochemical sensor composed of a composite of cerium oxide nanoclusters, gold nanoparticles, and a highly conductive carbon was created and utilized for the detection of hydroxyl free radicals. AuNPs were deposited onto a highly conductive carbon using a deposition-precipitation method, followed by the selective deposition of CeOₓ nanoislands onto the AuNPs by controlled surface reactions (CSR) to obtain small CeOₓ clusters that boost the electrochemical performance of the sensor. Electrochemical techniques such as cyclic voltammetry (CV) and electrochemical impedance spectroscopy (EIS) were used to characterize the signals and display them in terms of electrical current and impedance generated by the interaction between the composite and hydroxyl free radicals. The CV results revealed that the developed sensor could accurately and selectively detect ·OH in the Fenton reaction. The sensor demonstrated a linear relationship between the current peak and ·OH concentration in the range 0.05-0.5 mM and 0.5-5 mM with a limit of detection (LOD) of 58 μM. In addition, EIS studies indicated that this electrochemical sensor could distinguish between ·OH and similar reactive oxygen species (ROS), such as hydrogen peroxide (H₂O₂). Additional merits, such as reproducibility, repeatability, and stability of the sensor were also confirmed.

### Materials and Methods

Tris (cyclopentadienyl) cerium (III) and highly conductive carbon Vulcan XCmax 22 were obtained from Strem Chemicals, Inc. and Cabot, USA, respectively. Tetrahydrofuran (99.9%, extra pure, anhydrous, stabilized with BHT), 30 wt % hydrogen peroxide solution, iron (II) sulfate heptahydrate (>99%), gold (III) chloride trihydrate, ammonia solution 28%-30%, and sulfuric acid 96% were purchased from Sigma-Aldrich (USA). Screen-printed carbon electrodes composed of a 2 mm-diameter carbon working electrode, a carbon auxillary electrode, and an Ag/AgCl reference electrode were purchased from Pine Instruments, USA. A Gamry Reference 600 potentiostat (Gamry Instruments, USA) was used to conduct cyclic voltammetry (CV) and electrochemical impedance spectroscopy (EIS).

### Synthesis of Carbon-Supported Gold Nanoparticles (Au/Carbon)

Gold nanoparticles were supported onto a highly conductive carbon using the deposition-precipitation method. In order to synthesize a 5 wt % Au/carbon sample, ˜0.8 g of the gold precursor (gold (III) chloride trihydrate) was weighed and added to 400 ml of DI water under stirring. The pH of the gold solution was adjusted to 9 through the drop-by-drop addition of a 2.5 M ammonia solution. Then, 7.5 g of Vulcan XCmax 22 was added, and the pH was adjusted to 9 once again. The mixture was then stirred at 1100 rpm for 6 h. After filtration, the sample was thoroughly washed with DI water to ensure the removal of chloride ions. The recovered solid was dried overnight in an oven at 60° C. Then, the sample was reduced under H₂ at 350° C. (0.5° C. min⁻¹ ramp) for 4 h. After cooling the sample to room temperature, the sample was passivated under 1% O₂/Ar for 30 min.

Decoration of Carbon-Supported Gold Nanoparticles with CeOₓ Nanoislands

An inverse CeOₓ—Au/carbon nanocomposite with a theoretical Au:Ce atomic ratio of 1:0.075 was produced by selectively depositing cerium oxide onto AuNPs by CSR. To do so, the Au/carbon sample was re-reduced in a Schlenk tube at 300° C. (0.5° C. min⁻¹ ramp) under flow of H₂ for 2 h to remove the passivation layer, then sealed under H₂ atmosphere and transported to a glove box containing ultra-high purity argon. After dissolving 0.0845 g of tris (cyclopentadienyl) cerium (III) in 97.5 ml of anhydrous THF, 15 ml of the solution was added to the reduced Au/carbon sample and stirred overnight. The solvent was then evaporated using a Schlenk line, followed by reduction at 300° C. (0.5° C. min⁻¹ ramp) under H₂ flow for 2 h. Finally, the sample was passivated at ambient temperature for 30 min with 1% O₂/Ar. Additionally, a ˜0.5 wt % CeOₓ/carbon composite was synthesized to compare their electrochemical performance.

Transmission electron microscopy (TEM) and energy dispersive X-ray spectroscopy (EDS) were used to examine the distribution of AuNPs on the carbon support and their decoration with CeOₓ nanoislands. As the CeOₓ—Au/carbon sample contained a low CeOₓ loading (theoretical Au:Ce atomic ratio=1:0.075) to ensure the small size and high concentration of Ce³⁺ sites, its characterization by EDS proved to be difficult. As a result, a new CeOₓ—Au/carbon sample with a theoretical Au:Ce atomic ratio=1:0.45 was synthesized using three successive CSR cycles (3×Au:Ce=1:0.15) with the purpose of corroborating the selective deposition of CeOₓ onto the AuNPs (sample labelled as 3×CeOₓ—Au/carbon). This sample would not be ideal for the detection of ·OH, as larger cerium oxide domains possess lower Ce³⁺/Ce⁴⁺ ratios and reduced scavenging properties. TEM images were acquired using a high-resolution Hitachi H9500 microscope (SEM) at 300 kV. EDS maps were acquired in an ultra-high-resolution Hitachi SU9000 scanning electron microscope (SEM) at 30 kV with an Oxford AztecEnergy EDS system (X-MaxN 100 1E 100 mm² windowless ultra large solid angle SDD detector). Although most AuNPs appeared to be well dispersed on the carbon surface, EDS mapping was focused on the largest CeOₓ—Au particles due to the resolution of the equipment. Finally, the actual Au and Ce loadings on Au/carbon and CeOₓ—Au/carbon samples were determined by inductively coupled plasma optical emission spectroscopy (ICP-OES) at Galbraith Laboratories, Inc.

### Deposition of the CeOₓ—Au/Carbon Composite on the Electrode

First, a suspension of 10 mg of CeOₓ—Au/carbon composite powder in 10 ml of DI water was prepared. Then, to achieve homogeneity, the solution was sonicated for one hour. The CeOₓ—Au/carbon composite solution was then deposited onto the carbon working electrode by applying 8 μl using a micropipette. Finally, this was dried in an oven at 60° C. for 1 h. After drying, the sensor was rinsed with DI water and dried under slow flow of nitrogen. The CeOₓ—Au/carbon-modified electrode was then employed in the detection of ·OH from the Fenton reaction.

### Use of the CeOₓ—Au/Carbon-Modified Electrode for the Detection of ·OH Generated by the Fenton Reaction

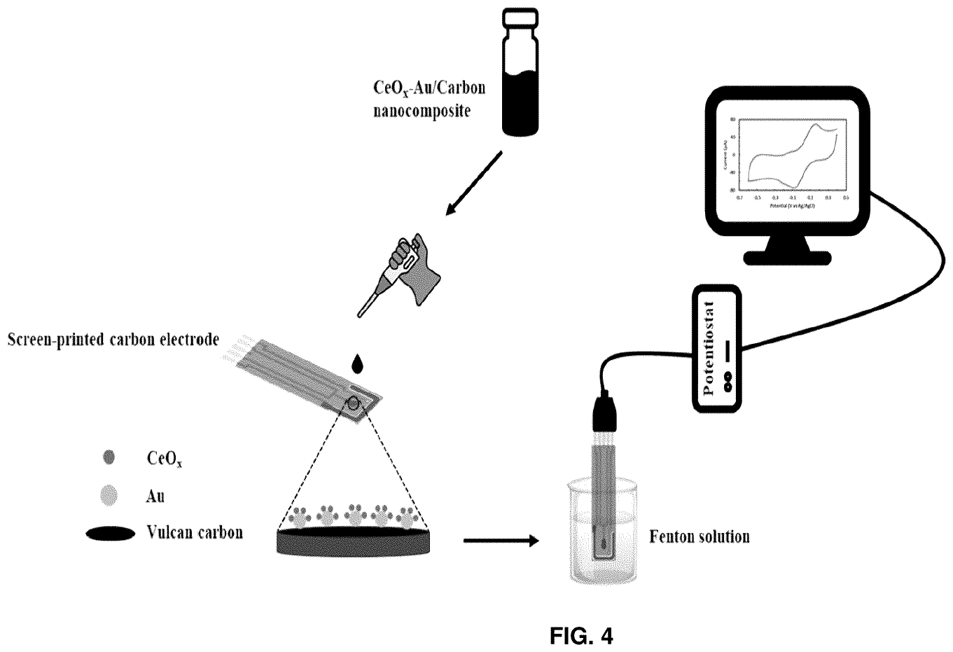

The Fenton reaction was employed to create ·OH for CV and EIS tests. By combining 10 mM solutions of H₂O₂ and FeSO₄·7H₂O in equal volumes, the Fenton reaction generates ·OH through the reduction of H₂O₂ in the presence of iron (II) ions. Then, the CeOₓ—Au/carbon-modified electrode was immersed into the Fenton solution, and the interaction between ·OH and the electrode was monitored by CV and EIS. CV experiments were performed in a potential range of −0.6 to 0.4V and at 100 mVs⁻¹ scan rate. EIS measurements were done in a frequency range of 0.01-10,000 Hz with AC and DC voltage of 5 mV and 0.23 V, respectively. FIG. 4 illustrates the procedure used for the modification of the electrode with the CeOₓ—Au/carbon nanocomposite, as well as the experimental setup for the detection of ·OH.

### Results

### Characterization

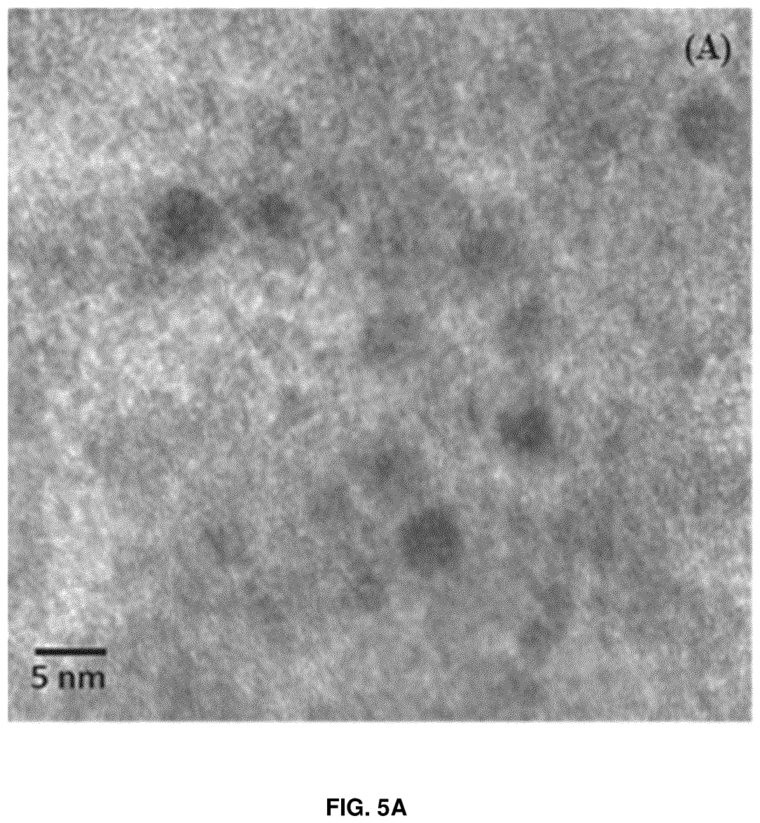

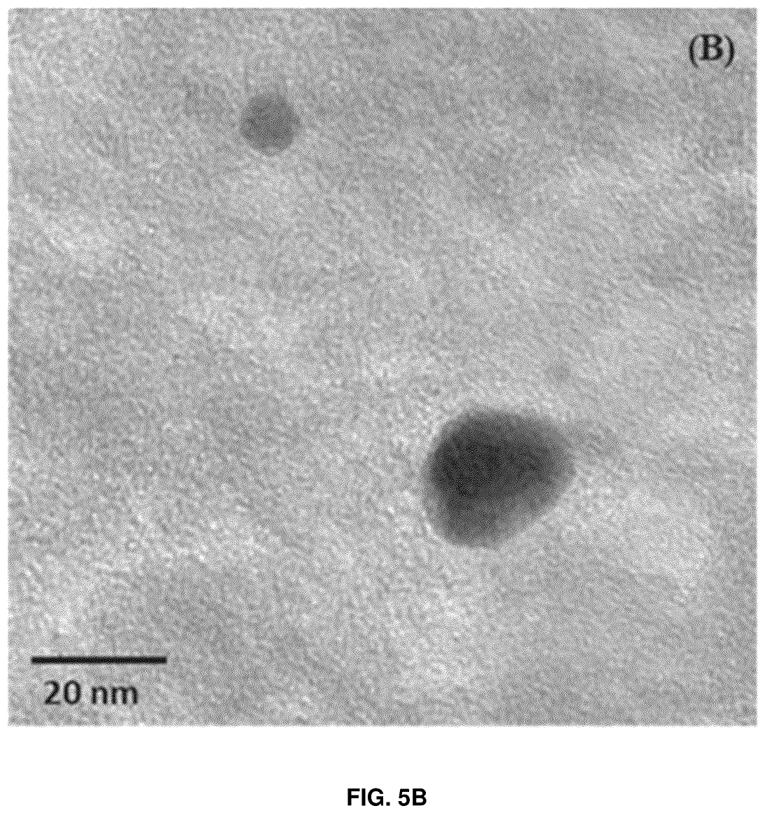

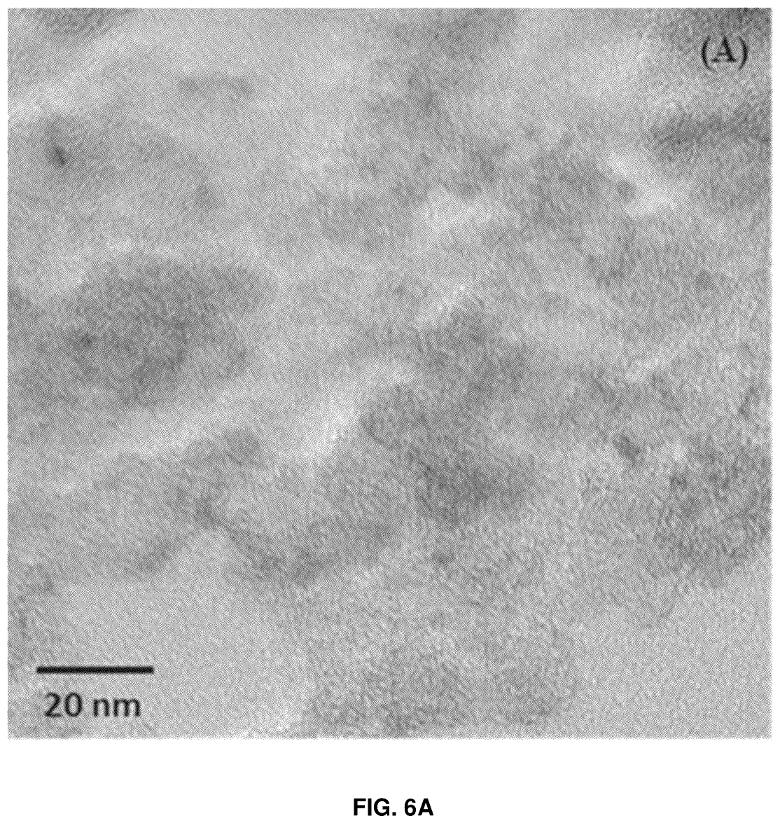

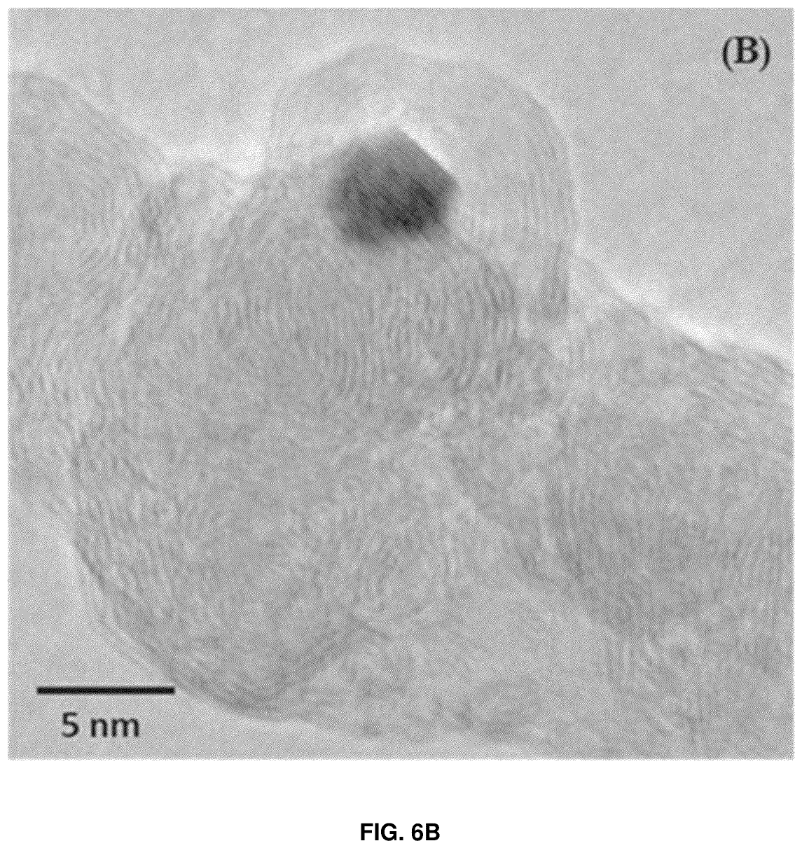

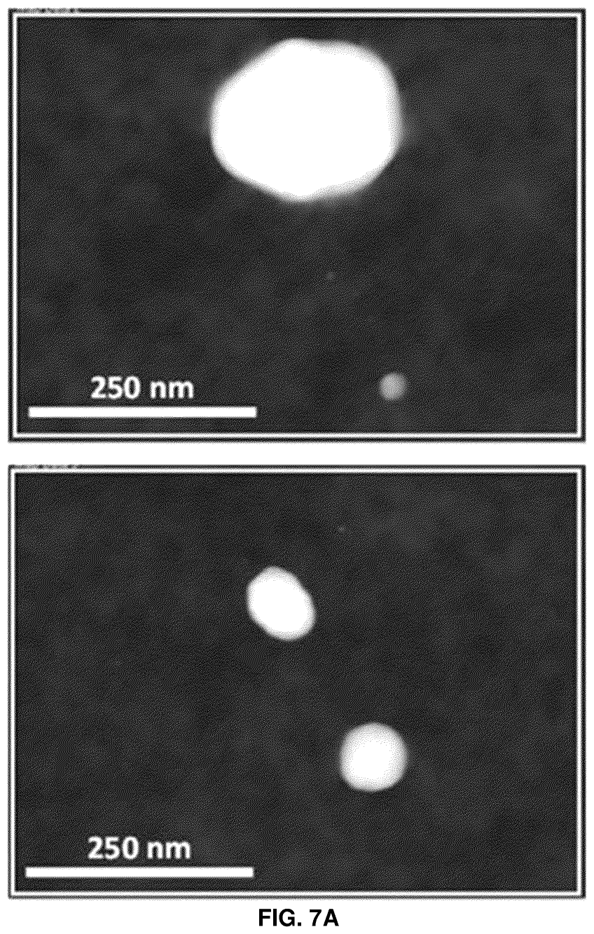

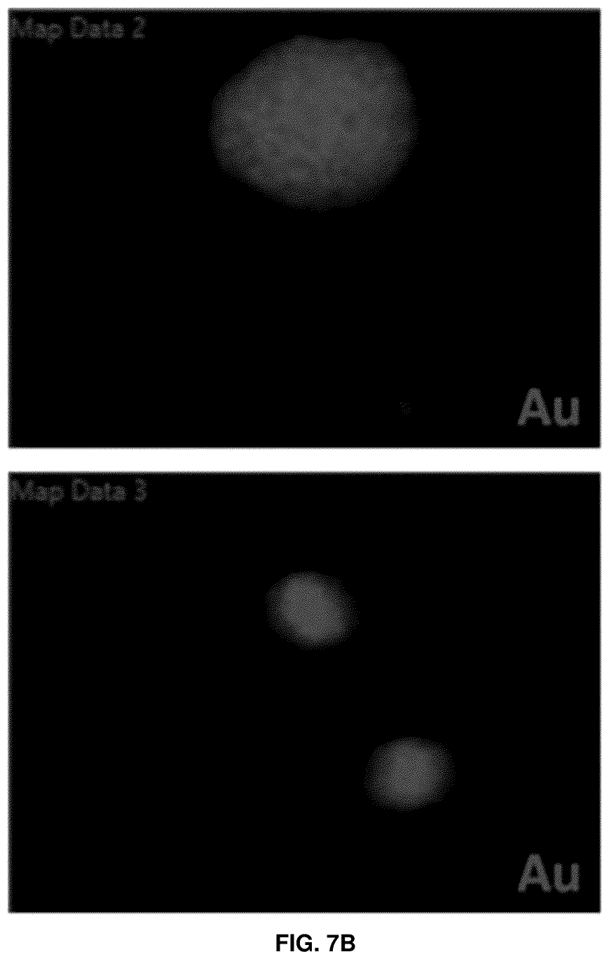

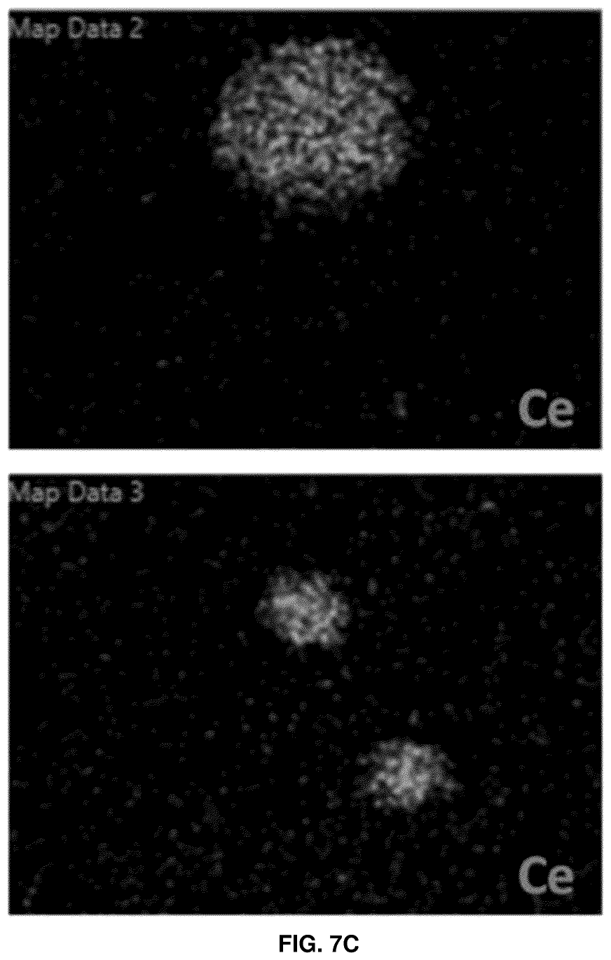

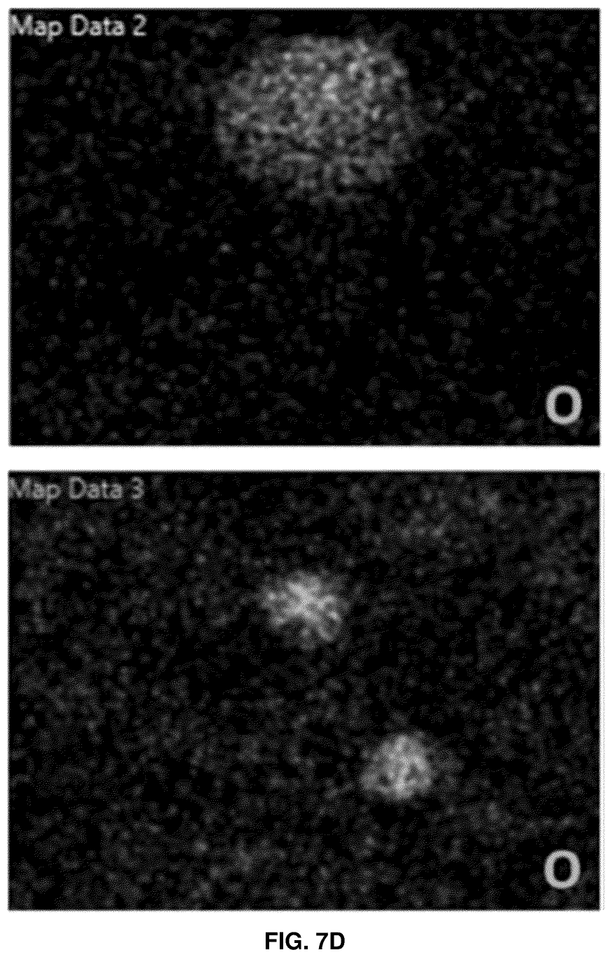

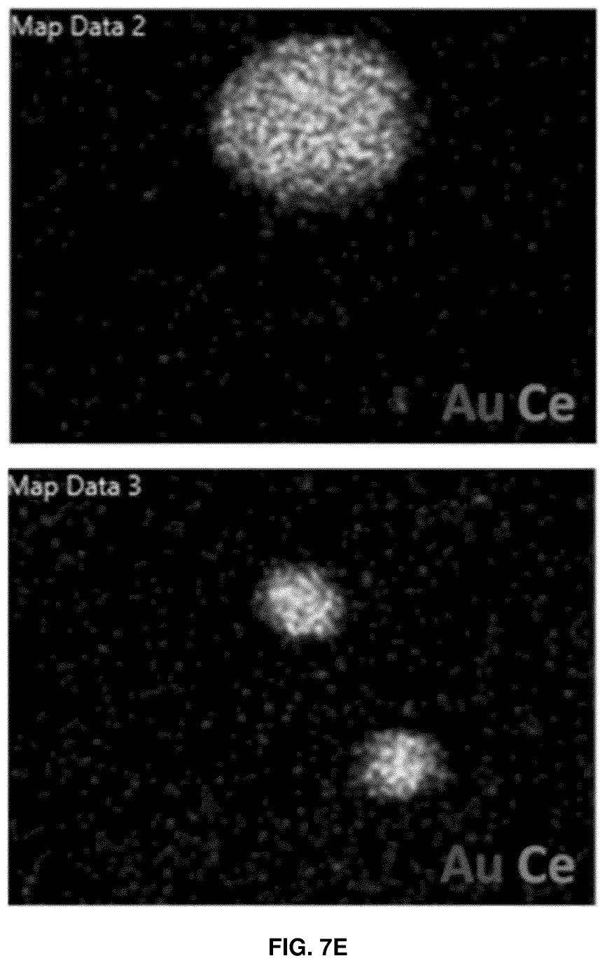

The effectiveness of the deposition-precipitation technique for the dispersion of AuNPs on carbon and the CSR method for the selective deposition of CeOₓ onto AuNPs was assessed using different characterization techniques. As can be seen in FIGS. 5A-5B, AuNPs were evenly distributed on the carbon support, although some large particles were also found. Thus, it is confirmed that the deposition-precipitation method can successfully be used to produce a well-dispersed Au/carbon material. As shown in FIGS. 6A-6B, nanoparticles maintain a uniform distribution even after 3 cycles of CeOₓ deposition. Additionally, EDS mapping (FIGS. 7A-7E) confirmed the selective deposition of CeOₓ nanoislands onto the carbon-supported AuNPs. Although most of the AuNPs were quite small, EDS mapping focused on the large nanoparticles due to the relatively low resolution of the SEM-EDS.

The TEM images in FIGS. 5A-5B show the gold nanoparticles evenly distributed on the carbon support with some large particles, and the TEM images in FIGS. 6A-6B show that the gold nanoparticles maintain a uniform distribution even after the three cycles of cerium oxide deposition. The EDS elemental mapping in FIGS. 7A-7E confirms the selective deposition of cerium oxide nanoislands onto the carbon-supported gold nanoparticles. This sample was not used for the detection of hydroxyl free radicals due to the larger cerium oxide domains possessing lower Ce³⁺/Ce⁴⁺ ratios and reduced scavenging properties, but is helpful in assessing the success of the techniques used for the placement of the gold nanoparticles on the carbon support and the cerium oxide nanoislands on the gold.

ICP-OES was employed to determine the actual Au and Ce loading in the Au/carbon and CeOₓ—Au/carbon samples. Not surprisingly, both Au/carbon and CeOₓ—Au/carbon samples presented similar gold loadings (4.21 wt % and 4.32 wt % Au, respectively), although the second also contained 0.227 wt % Ce. This corresponds to an Au:Ce atomic ratio=1:0.074, which is almost identical to the theoretical value (Au:Ce atomic ratio=1:0.075). This demonstrates the success of the controlled surface reaction (CSR) method for the incorporation of CeOₓ to the sample. Finally, the CeOₓ/Carbon sample presented a 0.49 wt % Ce loading.

Detection of ·OH Generated by the Fenton Reaction with the CeOₓ—Au/Carbon-Modified Sensor

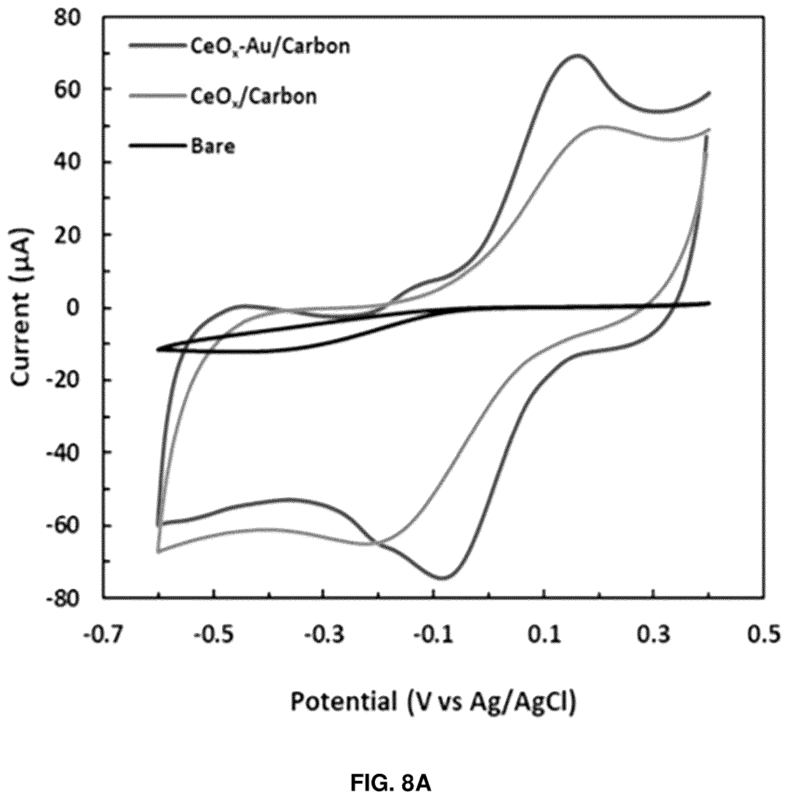

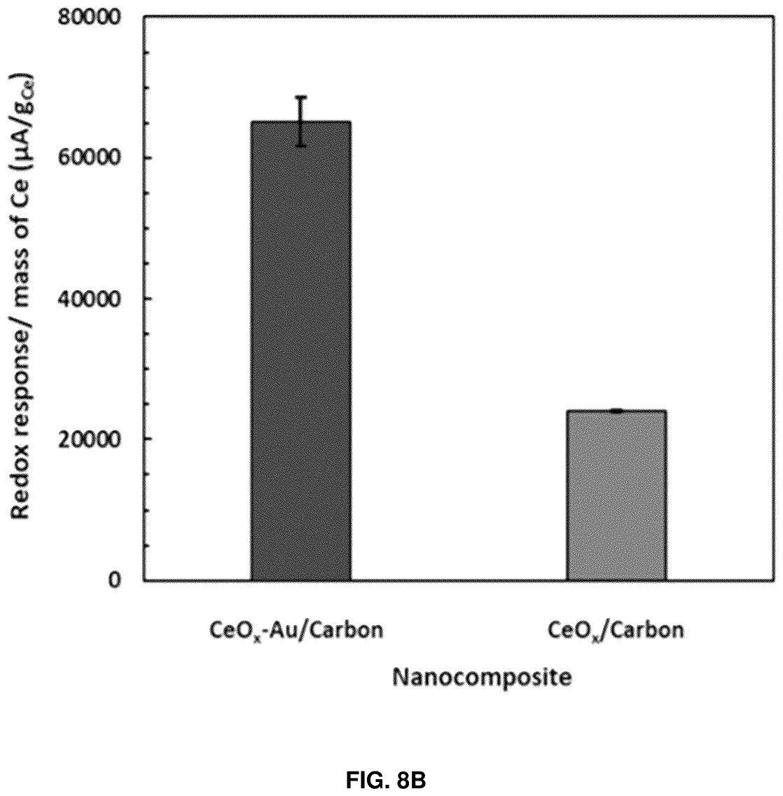

FIG. 8A shows the oxidation and reduction response (i.e., redox response) of the bare electrode and the electrode modified with CeOₓ—Au/carbon and CeOₓ/carbon to 5 mM ·OH produced by the Fenton reaction. The redox response of the sensor to ·OH was determined by the difference between the currents at the reduction and oxidation peaks, denoted as ΔA, which shows the redox reaction between ·OH and Ce³⁺ on CeOₓ. As can be seen in FIG. 8A, the current response of the CeOₓ—Au/carbon-modified electrode was found to be higher than that of the CeOₓ/carbon-modified electrode. Moreover, the redox peak potential difference of the CeOₓ—Au/carbon-modified electrode was considerably lower than that of the CeOₓ/carbon-modified electrode. The higher current response and the lower peak potential difference of the CeOₓ—Au/carbon-modified electrode compared to the CeOₓ/carbon-modified electrode are ascribed to the well-dispersed CeOₓ domains on the surface of the AuNPs, resulting in a high content of Ce³⁺ sites for ·OH scavenging. Moreover, AuNPs have electrocatalytic activity and increase the conductivity of electrochemical sensors. Therefore, the synergy between CeOₓ and AuNPs, which contributes to electrocatalytic activity, high conductivity, and the small size of CeOₓ via decoration of metal nanoparticles, provides the sensor with enhanced electrochemical performance in the Fenton reaction. In order to facilitate the comparison between the CeOₓ—Au/carbon and CeOₓ/carbon nanocomposites for ·OH detection, corresponding AAs were normalized in terms of the mass of Ce in the nanocomposite. As can be seen in FIG. 8B, the electrode modified with 0.49 wt % CeOₓ/carbon composite exhibited a normalized response nearly three times lower than the 0.227 wt % CeOₓ—Au/carbon composite. The lower response of the CeOₓ/carbon nanocomposite can be attributed to the agglomeration of CeOₓ nanoparticles on the carbon surface upon thermal treatment, thus resulting in a lower content of Ce³⁺ sites. In contrast, the decoration of carbon-supported AuNPs with cerium oxide resulted in smaller CeOₓ domains with a high concentration of Ce³⁺ sites, leading to an enhanced redox response to ·OH.

Effect of the pH on the Redox Reaction Between. OH and CeOₓ

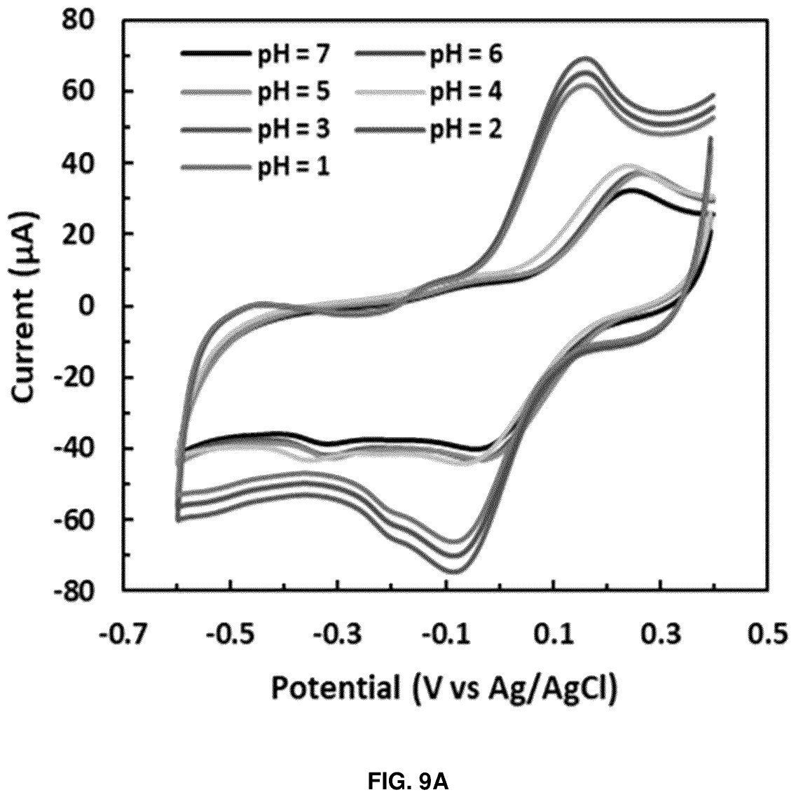

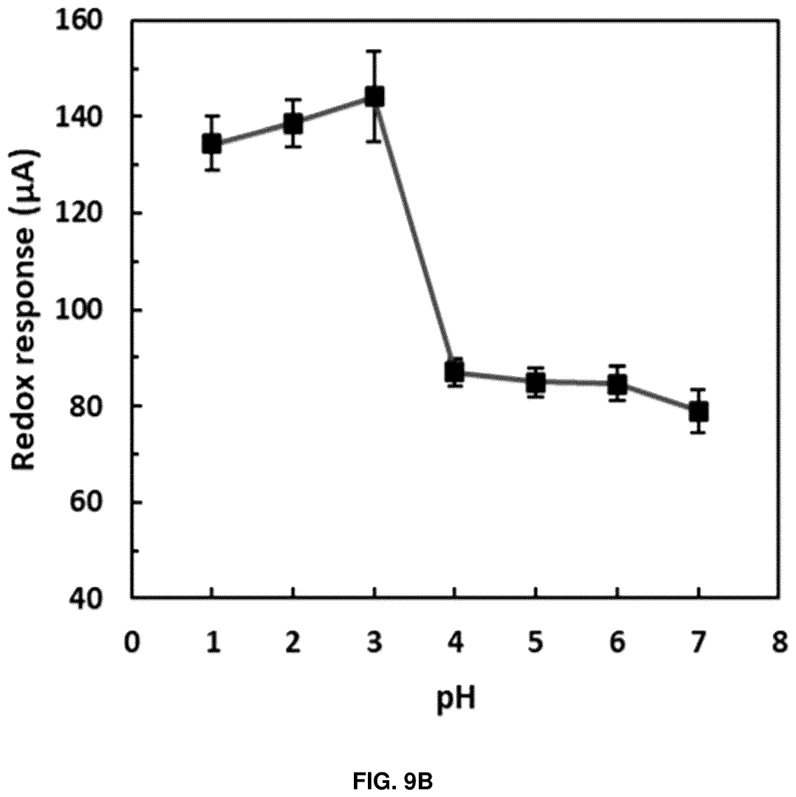

The impact of pH on the sensitivity for the detection of ·OH was studied in the pH range of 1 to 7. As depicted in FIGS. 9A-9B, the detection sensitivity of ·OH in the pH range of 4 to 7 was significantly low. On the other hand, in more acidic environments (pH≤3), the redox response was higher than that for pH 4-7. Without wishing to be bound by theory, there are different possible reasons behind this behavior: (a) high pH conditions (pH>4) would drastically restrict the availability of Fe³⁺, since these would predominantly precipitate as ferric hydroxide (Fe(OH)₃) in alkaline environments, (b) H₂O₂ decomposition into O₂ and H₂O at pH>5, (c) the complexation of Fe²⁺ occurs at low pH, resulting in a decreased availability of Fe²⁺ to generate ·OH, and (d) at pH<3, the generated ·OH can be neutralized by excess H⁺ ions, thereby decreasing its reaction rate. As a result, pH=3 was chosen as the pH to investigate the analytical factors for the detection of ·OH produced by the Fenton reaction.

Effect of the Scan Rate on the Detection of ·OH with the CeOₓ—Au/Carbon-Modified Electrode

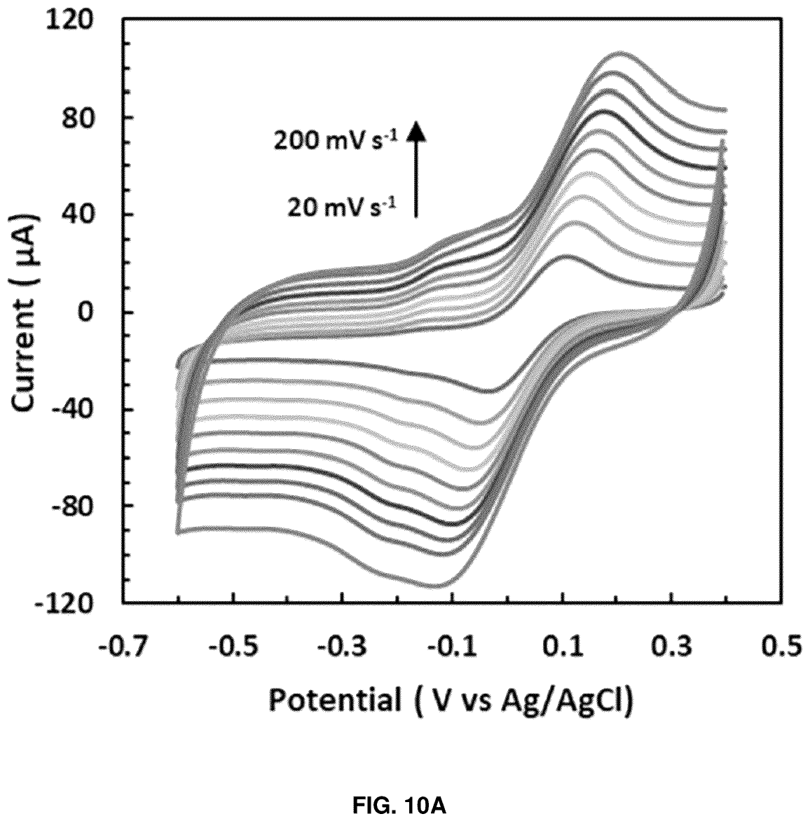

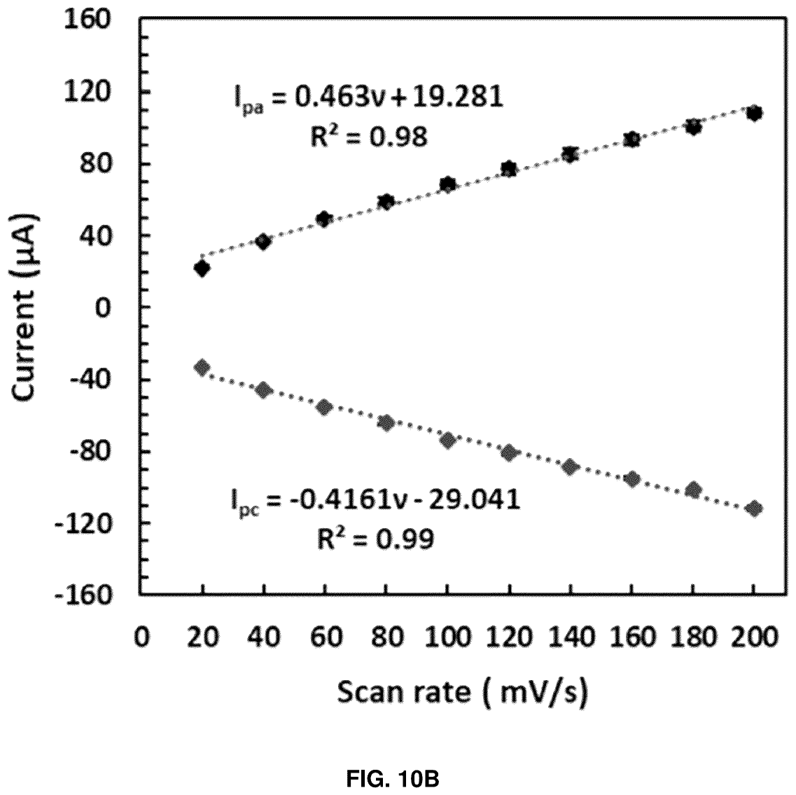

The effect of the scan rate on the sensor performance was examined using CV in 5 mM ·OH. As depicted in FIG. 10A, both cathodic and anodic peak currents gradually increased as the scan rate increased from 20 to 200 mV s⁻¹. The peak current response of the CeOₓ—Au/carbon-modified electrode displayed a linear relationship with the scan rate, as shown in FIG. 10B, indicating that the electrochemical process on the electrode surface corresponds to the classical surface control mechanism. Therefore, ·OH in the solution were initially absorbed on the electrode surface and subsequently, the electrochemical redox reaction took place. As seen in FIG. 10A, an increase in the scan rate generated a slight shift in the anodic and cathodic peak potentials. At the same time, the oxidation peak current change amount (Iₚₐ) obtained with the CeOₓ—Au/carbon-modified electrode differs from the reduction peak current change amount (I_{pc}). This phenomenon demonstrates that the redox reaction is quasi-reversible.

The Randles-Sevcik (R-S) equation and cyclic voltammetry of ferricyanide were used to determine the effective surface area of the modified electrode:

$${I}_{p} = 2.69 \times 1 {0}^{5} \cdot A \cdot {n}^{\frac{3}{2}} \cdot {D}^{\frac{1}{2}} \cdot {v}^{\frac{1}{2}} \cdot C ,$$

where Iₚ represents the current peak of the ferricyanide voltammogram, D is the ferricyanide diffusion coefficient ((6.70×10⁻⁶±0.02)×10⁻⁶ cm²·s⁻¹), n is the number of transferred electrons in the redox reaction (n=1 for ferricyanide), v is the scan rate (100 mV s⁻¹), C is the concentration of the ferricyanide solution (0.1 M), and A denotes the effective surface area of the modified electrode to be calculated.

To obtain Iₚ, the cyclic voltammogram with the CeOₓ—Au/carbon-modified electrode in a 0.1 M ferricyanide solution was recorded. Based on the known parameters and the R-S equation, the effective surface area of the CeOx-Au/carbon-modified electrode in the present example was 0.056 cm². Remarkably, the effective surface area of the CeOₓ—Au/carbon-modified electrode is larger than that of the bare electrode before modification (0.031 cm²), demonstrating that there are more electroactive sites on the surface of the CeOₓ—Au/carbon-modified electrode and its good electrical conductivity.

Finally, the R—S equation was used with the calculated A and the Iₚₐ and I_{pc} values obtained from the ·OH cyclic voltammogram at the scan rate of 100 mV s⁻¹ to determine the diffusion coefficients, obtaining Dₚₐ=8.27×10⁻³ cm² s⁻¹ and D_{pc}=9.52×10⁻³ cm² s⁻¹. Since Dₚₐ and D_{pc} are very similar (D_{pc}/Dₚₐ=1.15), it can be concluded that the oxidation rate of Ce³⁺ and reduction rate of Ce⁴⁺ are nearly the same. This is in line with the fact that the redox reaction on the electrode is quasi-reversible.

### Calibration Curve

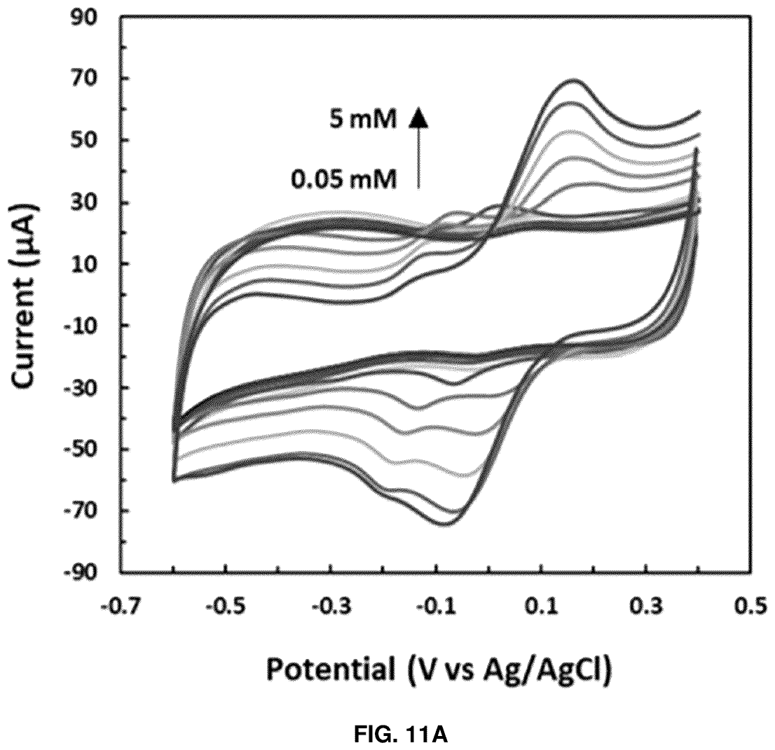

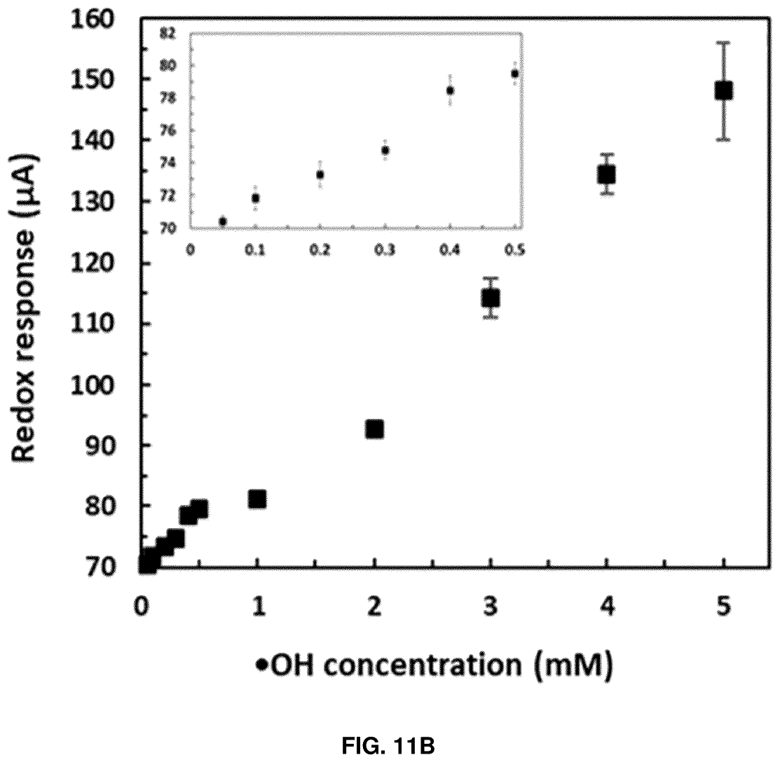

CV analysis was used to examine the response of the CeOₓ—Au/carbon-modified electrode to variable ·OH concentrations between 0.05 and 5 mM produced by the Fenton reaction. As seen in FIGS. 11A-11B, the redox response of the sensor increases as the concentration of ·OH rises. Also, the sensor exhibits a linear relationship between the redox response (AA) and ·OH concentration in the range 0.05-0.5 mM (ΔA=20.54 C+69.42) with an R-square (R²) of 0.98 and 0.5-5 mM (ΔA=16.28 C+66.30) with an R-square (R²) of 0.98. The equation 3.3×SD/b was employed to determine the limit of detection (LOD) of the sensor, where SD and b represent the standard deviation of the blank and the slope of the regression line, respectively. The LOD of the CeOₓ—Au/carbon-modified sensor for ·OH was 58 μM, which is comparable to other sensors (Table 1).

TABLE 1
Comparison of analytical •OH detection
using different electrochemical sensors

| | | LOD |
|---|---|---|
| Sensor | Linearity range (M) | (μM) |
| CeNP^{a)}/GO^{b)}/SPCE^{c)} | 1 × 10 [symbol] to 1 × 10 [symbol] | 100 |
| CeNP/GO/PB^{d)}/SPCE | 1 × 10 [symbol] to 1 × 10 [symbol] | 60 |
| N—C^{e)}/AuNPs^{f)}/DNA/MCH^{g)}GCC^{h)} | 5 × 10⁻⁵ to 5 × 10 [symbol] | 25 |
| DNA2-AuNPs/MCH/DNA1/Au | 5 × 10⁻⁷ to 1 × 10 [symbol] | 3 |
| CeOₓ—Au/Carbon/SPCE | 5 × 10 [symbol] to 5 × 10 [symbol] and | 58 |
| | 5 × 10 [symbol] to 5 × 10 [symbol] | |

^{a)}Cerium nanoparticles
^{b)}Graphene oxide
^{c)}Screen-printed carbon electrode
^{d)}Prussian blue
^{e)}nitrogen doped porous carbon nanostructures
^{f)}Gold nanopanicles
^{g)}6-mercaptohexanol
^{h)}Glassy carbon electrode. [symbol]
indicates data missing or illegible when filed

### Selectivity, Reproducibility, Repeatability, and Stability of the CeOₓ—Au/Carbon-Modified Electrode

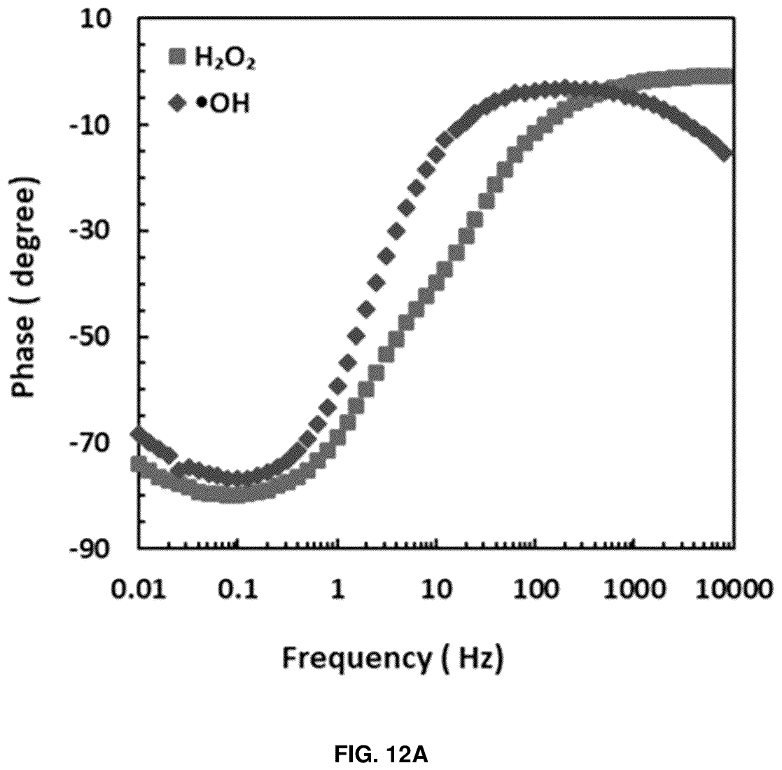

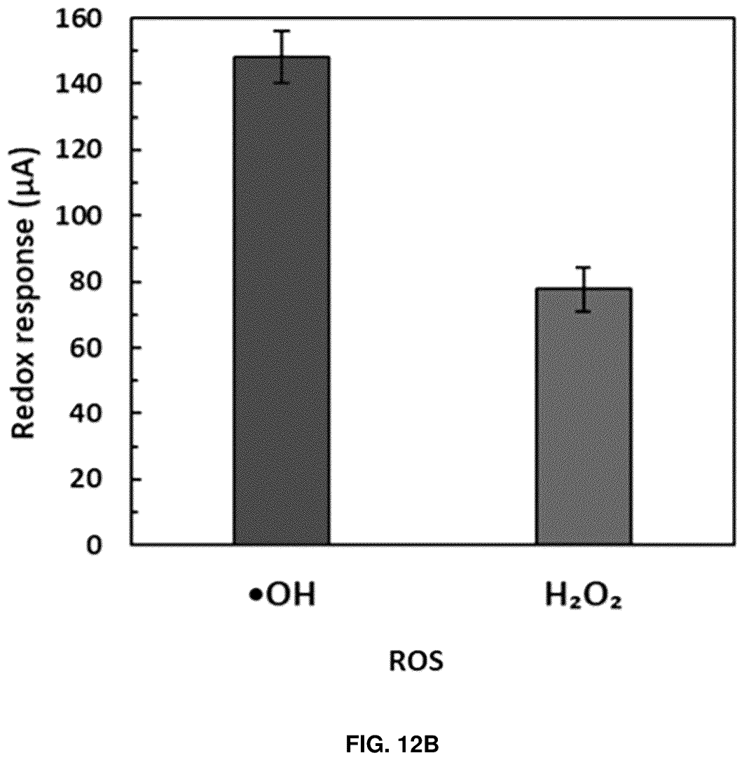

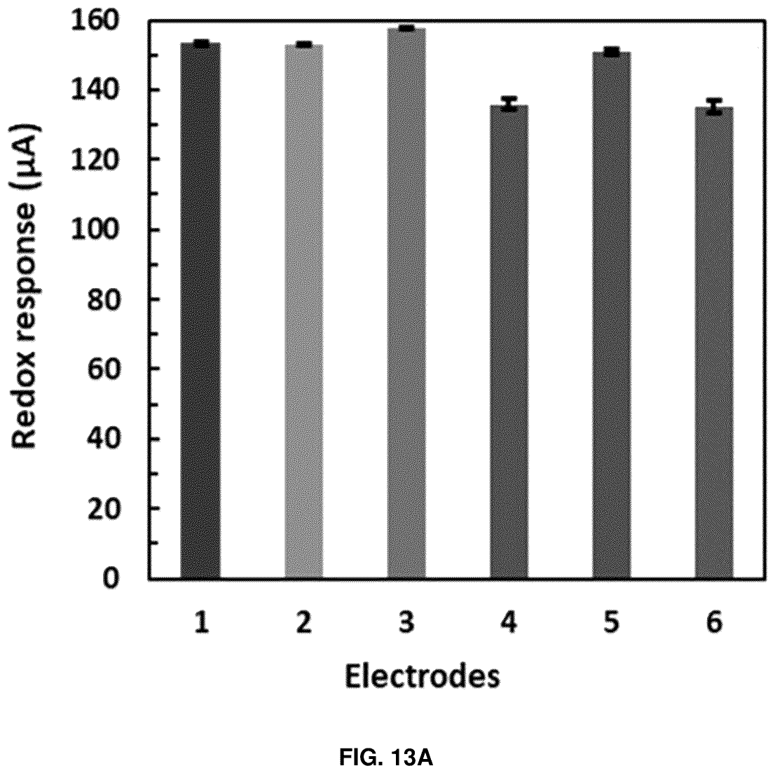

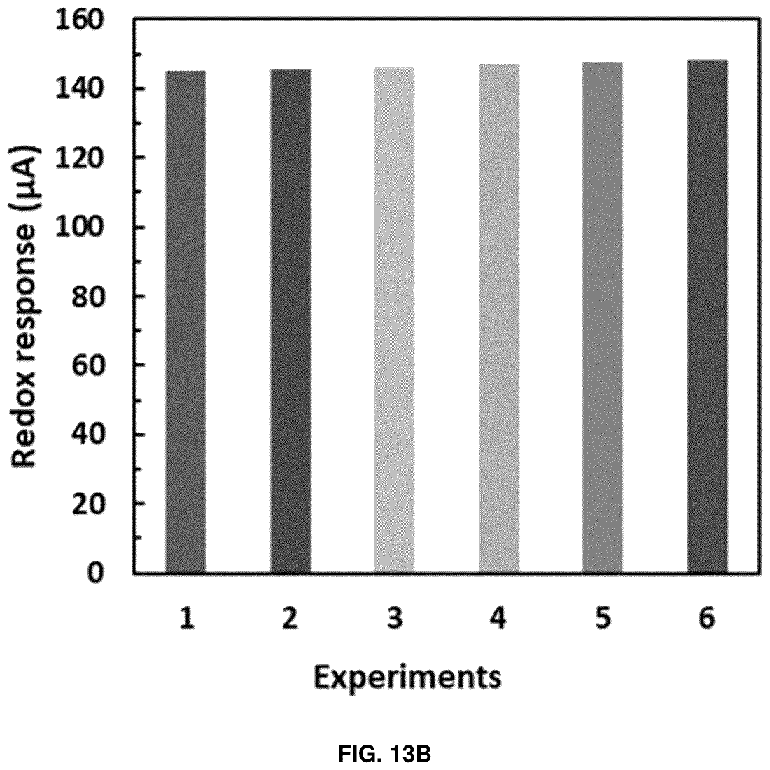

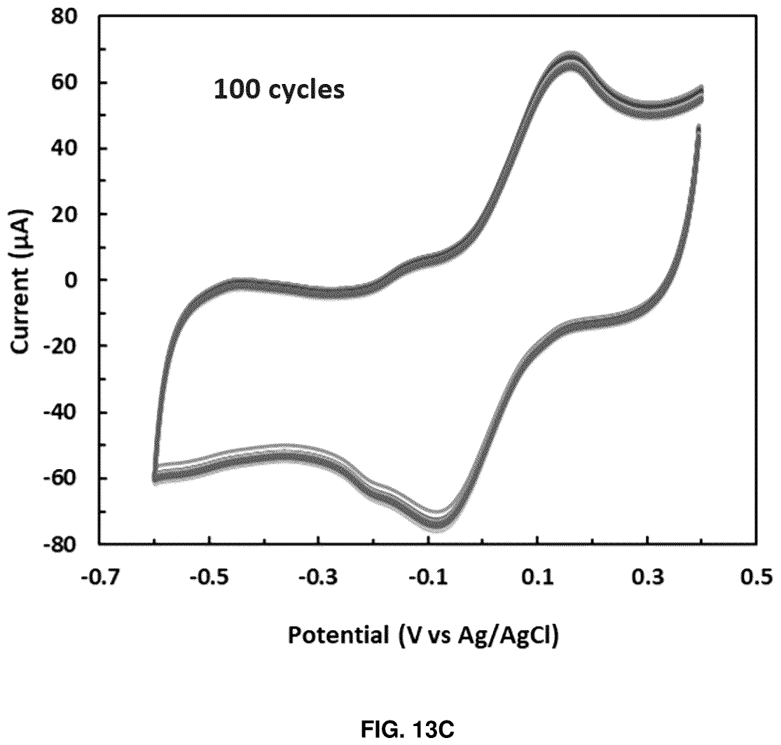

Selectivity is among the most important analytical parameters for sensors. EIS was employed to investigate the selectivity of the sensor. As seen in FIG. 12A, the CeOₓ—Au/carbon-modified electrode showed not only the ability to detect ·OH, but also the ability to differentiate ·OH produced in the Fenton reaction from a similar oxidizing chemical, such as H₂O₂. As shown in the Bode plot (FIG. 12A), the pattern of phase angle shift for ·OH differs from that for H₂O₂. Interestingly, while only a change was noticed at 0.1 Hz for H₂O₂, phase angle shifts for ·OH occurred at 0.1 and 130 Hz. FIG. 12B shows the redox response of the CeOₓ—Au/carbon-modified electrode toward 5 mM ·OH and 10 mM H₂O₂ (two times more concentrated), which confirmed the high selectivity of the modified sensor towards ·OH. The reproducibility of measurements was also confirmed by the analysis of a 5 mM ·OH solution with six independent CeOₓ—Au/carbon-modified electrodes, obtaining a relative standard deviation (RSD) of 5.97%, which indicated the great reproducibility of the measurements (FIG. 13A). The repeatability was also investigated by analyzing 5 mM ·OH with the same electrode six times, getting a RSD of 0.83%, which demonstrated the excellent repeatability of the sensor (FIG. 13B). In addition, it was observed that the peak current of CV did not change significantly after more than 100 cycles of continuous scanning at 100 mV s⁻¹, also pointing to the excellent stability of the nanocomposite (FIG. 13C).

### CONCLUSIONS

A platform for the detection of ·OH with high sensitivity and selectivity was developed by integrating CeOₓ, AuNPs, and a highly conductive carbon with electrochemical techniques. First, the deposition-precipitation method was successfully employed to disperse AuNPs on carbon (Au/carbon). Then, a controlled surface reaction approach was used to decorate the surface of the AuNPs with CeOₓ nanoislands for ·OH scavenging. The CeOₓ—Au/carbon-modified electrode showed three times higher current response per mass of Ce than a CeOₓ/carbon-modified electrode. The synergistic effect of CeOₓ and AuNPs, which is reflected on the reduced size of the CeOₓ domains via AuNPs decoration and high conductivity, can boost the electrochemical signals and provide the sensor with excellent ·OH detection capability. The CeOₓ—Au/carbon-modified sensor demonstrated its ability to detect ·OH with a limit of detection of 58 μM. According to the results, the electrochemical process occurring at the electrode surface was in agreement with the classical surface control mechanism, the redox reaction being quasi-reversible. In terms of selectivity, the developed sensor displayed the capacity to distinguish ·OH from H₂O₂, which is important for its application in complex systems. Furthermore, the developed sensor demonstrated reproducibility, repeatability, and stability.

Certain embodiments of the compositions, devices, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions, devices, and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A sensing composition comprising:
a conductive support; and
a sensing matrix on the conductive support, wherein the sensing matrix comprises cerium oxide nanoparticles on, or intermingled with, metal nanoparticles.

2. The sensing composition of claim 1, wherein the metal nanoparticles comprise gold nanoparticles.

3. The sensing composition of claim 2, wherein the sensing matrix includes an atomic ratio of Au:Ce of about 1:0.075.

4. The sensing composition of claim 1, wherein the conductive support comprises a conductive, amorphous carbon.

5. The sensing composition of claim 1, wherein the conductive support comprises carbon black.

6. The sensing composition of claim 1, wherein the sensing composition is free of Prussian blue, graphene, and graphene oxide.

7. A sensor comprising the sensing composition of claim 1 in electrical communication with an electrode, wherein the electrode is configured to act as a transducer for the sensing composition, and the sensor device is capable of detecting hydroxyl radicals generated by the Fenton reaction.

8. The sensor of claim 7, wherein the electrode is a working electrode on a sensing area and the sensor further comprises a counter electrode on the sensing area.

9. The sensor of claim 7, wherein the metal nanoparticles comprise gold nanoparticles.

10. The sensor of claim 7, wherein the electrode is a screen-printed carbon electrode.

11. The sensor of claim 10, wherein the screen-printed carbon electrode comprises a carbon working electrode, a carbon auxiliary electrode, and an Ag/AgCl reference electrode.

12. The sensor of claim 7, wherein the sensor is in a hand-held sensor device.

13. A method of detecting free radicals, the method comprising exposing the sensor of claim 7 to free radicals, and analyzing cyclic voltammetry or electrochemical impedance spectroscopy data from the sensor device to detect free radicals.

14. The method of claim 13, wherein the free radicals comprise hydroxyl radicals or hydrogen peroxide.

15. A method for making the sensing composition of claim 1, the method comprising:
depositing or precipitating metal nanoparticles onto a conductive carbon support to form carbon-supported metal nanoparticles; and
decorating the carbon-supported metal nanoparticles with cerium oxide nanoparticles to form a sensing composition.

16. The method of claim 15, wherein the decorating comprises selectively depositing CeOₓ nanoislands onto the metal nanoparticles by controlled surface reactions to create small CeOₓ clusters.

17. The method of claim 15, further comprising making a sensor device by electrically contacting the sensing composition with an electrode.

18. The method of claim 14, wherein the depositing or precipitating metal nanoparticles comprises:
dissolving a gold precursor in a solvent to obtain a solution;
adjusting the pH of the solution to 9;
adding a conductive, amorphous carbon to the solution and adjusting the pH of the solution to 9 again;
stirring and filtering the solution to obtain a Au/carbon composite;
washing the Au/carbon composite to remove anions from the gold precursor;
drying the Au/carbon composite;
reducing the Au/carbon composite to form a reduced Au/carbon composite; and
passivating the reduced Au/carbon composite to form carbon-supported nanoparticles.

19. The method of claim 18, wherein the gold precursor comprises gold (III) chloride trihydrate.

20. The method of claim 15, wherein the decorating comprises:
reducing the carbon-supported nanoparticles to remove a passivation layer and obtain reduced carbon-supported nanoparticles;
dissolving a cerium oxide precursor in a solvent to obtain a precursor solution;
mixing the precursor solution with the reduced carbon-supported nanoparticles to obtain a reaction solution;
removing the solvent from the reaction solution to obtain a product;
reducing the product to obtain a reduced product; and
passivating the reduced product to form the sensing composition.

21. The method of claim 20, wherein the cerium oxide precursor comprises tris(cyclopentadienyl)cerium(III).
